(19) United States
(12) Patent Application Publication
(10) Pub. No.: US 2008/0072406 A1
(43) Pub. Date: Mar. 27, 2008

(54) METHOD OF FACILITATING, TANGIBLY REPRESENTING, AND DISPLAYING MEMORIAL DONATION TRIBUTES

(76) Inventor: Hazel Piazza Sinclair, Covington, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/778,560

(22) Filed: Jul. 16, 2007

Related U.S. Application Data
(60) Provisional application No. 60/807,591, filed on Jul. 17, 2006.
(60) Provisional application No. 60/822,700, filed on Aug. 17, 2006.
(60) Provisional application No. 60/882,721, filed on Dec. 29, 2006.
(60) Provisional application No. 60/889,056, filed on Feb. 9, 2007.
(60) Provisional application No. 60/940,555, filed on May 29, 2007.

(51) Int. Cl. A61G 99/00; G06Q 30/00

(52) U.S. Cl. 27/1; 705/26

(57) ABSTRACT

An innovative method involves facilitating, symbolically representing and displaying charitable tributes in memory of a deceased person at a funeral service. The method includes making and/or facilitating donation tributes to a charity or charities to honor a loved one, friend, acquaintance or other deceased person and having the donation acknowledged by a representative keepsake that is displayed at the time a funeral service is being held in honor of the deceased.

### CROSS-REFERENCE TO RELATED APPLICATIONS

Incorporated herein by reference are my U.S. provisional patent applications Nos. 60/807,591, filed 17 Jul. 2006; 60/822,700, filed 17 Aug. 2006; 60/882,721, filed 29 Dec. 2006; 60/889,056, filed 9 Feb. 2007; and 60/940,555, filed 29 May 2007. Priority of these applications is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to an innovative method of facilitating and symbolically representing charitable donations and displaying charitable donation tributes in memory of a deceased person or thing (such as a pet) at the time of a funeral service. More particularly, the present invention relates to methods of making and/or facilitating donation tributes to a charity or charities to honor a loved one, friend, acquaintance or other deceased person and having the donation acknowledged by a representative keepsake/memento that is displayed at the time a funeral, wake, memorial service, and/or funeral alternative is being held in honor of the deceased.

2. General Background

Supporting Documentation and Rationale for the Invention

In 2003, the total number of reported deaths in the United States was 2,448,288. While this number decreased for 2004 and was projected to remain low for 2005, the annual mortality rate for Americans is still quite a considerable number.

In seemingly unrelated statistics is the fact that Americans increased their charitable donations to over $260 billion in 2005 alone, representing an annual increase of 6.4%. Consistently, the largest single source of donations is made by individuals. In 2005, private donations totaled $199 billion representing 76.5% of all charitable giving. This amount comprised 2.1% of the U.S. Gross Domestic Product (GDP) and 2.2% of Americans' after-tax income. In 2006, charitable donations rose to over $300 billion.

Computer technology has, without question, been the major factor contributing to the increase observed in philanthropy by facilitating on-line donations. For example, following 11 Sep. 2001, donations of $11 million were realized along with $17 million following the 2004 Tsunami in Asia. Records were then set in 2005 following Hurricanes Katrina and Rita with donations exceeding $26 million.

The Chronicle of Philanthropy recently reported that donations made through the Internet increased by almost 150% from the previous year. 167 Charitable groups reported receiving $911.9 million via the Internet.

Today myriad web sites pervade the Internet all dedicated to increasing charitable donations by using the web to simplify the process. Because a major charity's mail list may involve up to millions of letters, many of these Internet sites capitalize on this fact and stress the environmental contribution donors make as this on-line method substantially reduces the amount of paper charities would traditionally use mailing out literature to solicit donations.

Precipitating from the mortality rate and philanthropic statistics, we see a related consequence in the funeral industry, namely, charitable tributes. Over the last several decades, there has been a significant shift from the more traditional service where flowers are sent to honor the deceased to funerals where requests are made for charitable donations “in lieu of” or in addition to floral arrangements or other gifts.

While complying with requests for a donation “in lieu of” or in addition to flowers and/or other memorial gifts represents an act of respect and condolence, it fails to convey the warm sentiment evoked by a room filled with multiple arrangements of various types of flora. The place where the service is held seems stark, barren and cold without the uplifting colors and warmth that flowers offer. It also fails to console the surviving family and friends relative to the degree of love and respect demonstrated for the deceased because these tribute donations are mostly not even known about, much less displayed, at the time the funeral or memorial service is conducted. These deficiencies defeat the main objectives that funeral and memorial services were intended to provide. There is also an increasing trend in which funeral alternatives such as “celebrations” of a decedent's life are held as opposed to the more traditional types of funerals. These “celebrations” can be, for example, parties, dinners, receptions, gatherings at various venues such as the home of a person, parades, activities that the decedent enjoyed as well as “send-offs”. In some cases people are having the remains of cremation made into a stone that they can wear as a pendant. Others are requesting that they be buried at sea or in underwater cemeteries such as “Atlantis” off the coast of Florida, while others are having remains launched into space. Sometimes there is no public service at all but instead an event is held at a later time to honor the life and memory of a deceased person or thing.

Flowers have traditionally been sent to funeral homes to honor deceased persons. Increasingly, people are requesting that donations be made to one or more specified/unspecified charities instead of flowers and/or other memorial gifts. Being a perishable product, flowers have quite a short life span and even shorter time in which they are at their peak. Often, most of the arrangements sent to funerals are left at the burial site. Those that are brought home by the surviving family soon wilt and die, essentially becoming a lifeless gift that must be thrown away.

When a request for a donation to a charity in lieu of or in addition to flowers and/or other gifts is made, many times the place where one is being remembered, honored, memorialized, waked, etc. appears stark, devoid of the expression of love and respect that has come to be associated with flowers, plants and other present tangible gifts that are displayed. Oftentimes, to some, the sheer number of arrangements has come to represent the degree of affection and respect for them or their loved one.

The following possibly relevant US patents are incorporated herein by reference (the order of listing has no significance):

PAT. NO. Title

U.S. Pat. No. 6,253,998 Fund-raising terminal and method for accepting monetary contributions by use of an information bearing card

U.S. Pat. No. 6,092,052 Method of maximizing statistical data throughput at remotely located electronic donation processing devices, and electronic device for managing statistical information

U.S. Pat. No. 5,696,366 Method for streamlining the giving of contribution and gift commitments

U.S. Pat. No. 5,665,952 Method of streamlining the acknowledgment of a multiplicity of contribution or gift commitments made at a plurality of remote locations to distinct fund-raising organizations and gift recipients and system therefor

U.S. Pat. No. 5,663,547 Method of fund-raising with a keyless contribution and gift commitment management device.

### BRIEF SUMMARY OF THE PRESENT INVENTION

A “funeral service” as used herein means a funeral, a memorial service, a wake, or a funeral alternative held shortly after the death or discovery of the death or the presumption or declaration of the death of a person.

A “funeral” as used herein means a ceremony held in connection with the burial or cremation of a deceased person.

A “memorial service” as used herein means a ceremony honoring a deceased person whose body cannot be recovered or is donated to science and held shortly after his or her death or discovery of his or her death or declaration or legal presumption of his or her death, such as a service held in honor of a soldier or pilot who dies but whose body cannot be recovered.

A “wake” as used herein means a gathering of acquaintances prior to the funeral or memorial service of a deceased person.

A “funeral alternative” as used herein means a party or other celebration or gathering in honor of the deceased and held instead of or in addition to a funeral or a memorial service, but at around the same time as the funeral or memorial service (usually shortly after the death or discovery of the death or the presumption or declaration of the death of a person).

As used herein, “shortly” means the typical time for a funeral or memorial service, which is usually less than a week, in most cases less than two weeks, occasionally more than two weeks but less than a month, and in rare cases up to two months after the death or discovery of the death or the presumption or declaration of the death of a person.

A preferred embodiment of the present invention includes a method of marketing a memorial gift product to an honoring acquaintance that desires to honor a deceased person, preferably comprising the steps of:

a) providing one or more delivery service providers that enable delivery of the memorial gift product to a funeral service of the deceased person at a funeral service location;

b) enabling the honoring acquaintance to place an order for the memorial gift, said order including a price that is paid by the honoring acquaintance;

c) wherein the price in step “b” includes a donation to a charity; and

d) wherein the price in step “b” includes the service of delivery of a memento/keepsake that is delivered by one of the delivery service providers of step “a” to the location of step “a”.

Another embodiment of the present invention includes a method of marketing a memorial gift product, preferably comprising the steps of:

a) providing a network of delivery service providers that enable delivery of the memorial gift product to a funeral service for a deceased person at a selected funeral service location;

b) enabling a purchaser to place an order for the memorial gift product, the order including a price that is paid by the purchaser;

c) wherein the price in step “b” includes an amount of money that is a donation to a charity;

d) wherein the price in step “b” includes the delivery of a memento/keepsake that is delivered by one of the delivery service providers of the network of step “a” to the location of step “a”; and

e) wherein at least a portion of the amount of money of step “c” is paid to the charity.

The memento/keepsake is preferably not a floral product, or not entirely a floral product. The memento/keepsake is preferably a decorated object. The memento/keepsake can include a ribbon; the memento/keepsake can include a name of the honoring acquaintance placed on the ribbon. The memento/keepsake can include a name of the honoring acquaintance. The memento/keepsake can includes a name of the deceased.

The delivery service providers can be located in spaced apart locations, such as in different cities or in different countries. Preferably, at least some of the delivery service providers are florists.

Preferably, the mementos/keepsakes of step “d” are displayed in a common location at the funeral service of step “a”; preferably, the common location is a display and the mementos/keepsakes are attached to the display.

The mementos/keepsakes preferably carry inscribed information. The mementos/keepsakes preferably indicate the name of the honoring acquaintance. The mementos/keepsakes preferably indicate the name of the charity of step “c”. The mementos/keepsakes preferably indicate the name of the deceased person.

The delivery service provider preferably includes a vending machine that receives a payment from the honoring acquaintance and dispenses the memorial gift product to the honoring acquaintance and wherein in step “c” the donation is part of the payment to the vending machine.

A preferred embodiment of the present invention includes a method of facilitating charitable contributions, preferably comprising the steps of:

a) providing a plurality of donation acknowledgment mementos/keepsakes;

b) providing a donation acknowledgment memento/keepsake when a donor makes a contribution;

c) delivering the donation acknowledgment memento/keepsake to a funeral service location where the donation acknowledgment memento/keepsake is displayed,

d) recording the name of the charity, and the amount of the donation;

e) distributing donated funds to the charities.

A preferred embodiment of the present invention includes a method of facilitating charitable contributions, preferably comprising the steps of:

a) providing a plurality of donation acknowledgment mementos/keepsakes, each donation acknowledgment memento/keepsake including a space for the name of a charity and the name of a donor;

b) providing a donation acknowledgment memento/keepsake when a donor makes a contribution;

c) filling in the name of the charity and the name of the donor;

d) delivering the donation acknowledgment memento/keepsake to a funeral service location where the donation acknowledgment memento/keepsake is displayed;

e) as the donation acknowledgment mementos/keepsakes are distributed, recording the name of the donor, the name of the charity, and the amount of the donation;

f) distributing donated funds to the charities.

A preferred embodiment of the present invention includes a method of facilitating charitable contributions, preferably comprising the steps of:

a) providing a plurality of donation acknowledgment mementos/keepsakes, each donation acknowledgment memento/keepsake including a unique identifier and space for the name of a charity and the name of a donor;

b) providing a registry of the unique identifiers;

c) providing a donation acknowledgment memento/keepsake when a donor makes a contribution;

d) filling in the name of the charity and the name of the donor;

e) delivering the donation acknowledgment memento/keepsake to a funeral service location where the donation acknowledgment memento/keepsake is displayed;

f) as the donation acknowledgment mementos/keepsakes are distributed, recording in the registry of the unique identifiers the name of the donor, the name of the charity, and the amount of the donation;

g) distributing donated funds to the charities.

A keeper of the registry can be different from a deliverer of the donation acknowledgment mementos/keepsakes. Sometimes, neither a keeper of the registry nor a deliverer of the donation acknowledgment mementos/keepsakes is the charity receiving a donation. Sometimes, a deliverer of the donation acknowledgment mementos/keepsakes also delivers a display on which to display the mementos/keepsakes.

A preferred embodiment of the present invention includes a method of marketing a memorial gift product, preferably comprising the steps of:

a) providing at least one delivery service provider that enables delivery of the memorial gift product to a funeral service of the deceased person at a selected funeral service location;

b) enabling a purchaser to place an order for the memorial gift product through the delivery service provider,

c) said order comprising a price that is paid by the purchaser, a first portion of the price paid including a donation to a charity and a second portion of the price paid including a delivery of a memento/keepsake by the delivery service provider to the selected funeral service location.

A preferred embodiment of the present invention includes a method for acknowledging a charitable donation in tribute to a decedent preferably comprising the steps of:

a) making a donation to a charitable organization;

b) facilitating a monetary transaction for the donation;

c) representing the donation in a tangible form;

d) facilitating a monetary transaction for the form;

e) supplying the form; and,

f) exhibiting the form at an event memorializing the decedent.

Preferably a receipt evidencing the donation is provided. Preferably there is a display for the form and the display is exhibited. The step of facilitating a monetary transaction for the donation and the step of facilitating a monetary transaction for the form are preferably performed together. Preferably, the step of facilitating a monetary transaction for the donation, the step of facilitating a monetary transaction for the form and the step of providing a receipt evidencing the donation are performed together.

Preferably, representing the donation in a tangible form further comprises the steps of:
1) providing a place on the form for indicating the charitable organization;
2) providing a place on the form for indicating the donation;
3) providing a place on the form for indicating the decedent; and
4) providing a place on the form for indicating a donor.

Preferably, a plurality of forms are exhibited at an event memorializing the decedent.

A preferred embodiment of the present invention includes a method and apparatus for marketing a charitable gift donation, the method preferably comprising the steps of:

a) providing a database of charitable organizations to an honoring acquaintance wishing to make a charitable donation on behalf of a deceased;

b) facilitating the charitable donation on behalf of the deceased to at least one of the charities in the database of charitable organizations in step “a”; and

c) based on the donation of step “b”, causing a tangible memento/keepsake of the charitable donation to be displayed at a funeral service location for the deceased.

An embodiment of the present invention includes method and apparatus for marketing a charitable gift donation, the method preferably comprising the steps of:

a) providing a database of charitable organizations to an honoring acquaintance wishing to make a charitable donation on behalf of a deceased;

b) facilitating a charitable donation on behalf of the deceased to at least one of the charities in the database of charitable organizations in step “a”; and,

c) based on the donation of step “b”, causing a memento/keepsake of the charitable donation to be displayed on an electronic display at a funeral service location for the deceased.

Steps “a”, “b”, and “c” can be performed by a funeral home, or steps “a”, “b”, and “c” can be performed other than by a funeral home.

The tangible memento/keepsake can includes a personalized message selected by the honoring acquaintance. The tangible memento/keepsake can include an indication of the amount of the charitable donation of step “b”. Preferably, the tangible memento/keepsake includes an indication of the identity of the honoring acquaintance making the donation of step “b”. Preferably, the tangible memento/keepsake includes an indication of the identity of the charity to which the donation of step “b” is made.

Preferably, the tangible memento/keepsake includes an indication of the identity of the honoring acquaintance making the donation along with an indication of the identity of the charity to which the donation is made.

Preferably, step “b” is performed a plurality of times for multiple honoring acquaintances wishing to make charitable donations, and step “c” is performed a plurality of times causing multiple tangible mementos/keepsakes to be displayed at the funeral service location.

Preferably, in step “c” the tangible memento/keepsake is delivered to the funeral service location from a remote location by a delivery service.

A floral service can delivers the tangible memento/keepsake.

Preferably, a plurality of the multiple tangible mementos/keepsakes are displayed on a display. A plurality of the multiple tangible mementos/keepsakes can be displayed in a display case.

Preferably, the display is offered to a loved one of the honoring acquaintance whose funeral service is being held in step “c.”

Preferably, step “b” includes the use of the internet in making the charitable donation.

Preferably, in step “b” a credit card or other non-cash form of payment is used to make the charitable donation.

A single charge can be made for the charitable donation and the cost of the tangible memento/keepsake and its display can be part of the single charge.

Optionally, one can select from a plurality of types of tangible mementos/keepsakes to be displayed in step “c”.

Optionally, one can select from a plurality of sizes of tangible mementos/keepsakes to be displayed in step “c”.

A preferred embodiment of the present invention includes a method of marketing a memorial gift product to an honoring acquaintance desiring to honor a deceased person, preferably comprising the steps of:

a) providing one or more delivery service providers that enable delivery of the memorial gift product to the funeral service of the deceased person at a funeral service location;

b) enabling the honoring acquaintance to place an order for the memorial gift, said order including a price that is paid by the honoring acquaintance to a delivery service provider of step “a”;

c) wherein the price in step “b” includes a donation to a charity;

d) wherein the price in step “b” includes the service of delivery of a memento/keepsake that is delivered by one of the delivery service providers of step “a” to the funeral service location of step “a”; and

e) wherein the price in step “b” includes the service of the delivery service provider conveying the donation to the charity.

While the memento/keepsake can be a floral product, preferably it is not a floral product, or at least not entirely a floral product.

The memento/keepsake is preferably a decorated object. The memento/keepsake can include a ribbon; the memento/keepsake can include the name of the honoring acquaintance placed on the ribbon.

The memento/keepsake can include the name of the honoring acquaintance.

The memento/keepsake can include the name of the honoring acquaintance.

The delivery service providers can be located in spaced apart locations, such as in different cities or in different countries. Preferably, at least some of the delivery service providers are florists.

Preferably, the mementos/keepsakes of step “d” are displayed in a common location at the funeral service of step “a”; preferably, the common location is a display and the mementos/keepsakes are attached to the display.

The mementos/keepsakes preferably carry inscribed information. The mementos/keepsakes preferably indicate the name of the honoring acquaintance. The mementos/keepsakes preferably indicate the name of the charity of step “c”. The mementos/keepsakes preferably indicate the name of the deceased person.

The delivery service provider preferably includes a vending machine that receives a payment from the honoring acquaintance and dispenses the memorial gift product to the honoring acquaintance and wherein in step “c” the donation is part of the payment to the vending machine.

A preferred embodiment of the present invention includes a method of marketing a memorial gift product, preferably comprising the steps of:

a) providing a network of delivery service providers that enable delivery of the memorial gift product to the funeral service of the deceased person at a selected funeral service location;

b) enabling a purchaser to place an order for the memorial gift, said order including a price that is paid by the purchaser;

c) wherein the price in step “b” includes an amount of money that is a donation to a charity;

d) wherein the price in step “b” includes the service of a delivery of a memento/keepsake that is delivered by one of the delivery service providers of the network of step “a” to the funeral service location of step “a”; and

e) wherein the amount of money of step “c” is paid to the charity.

While the memento/keepsake can be a floral product, preferably it is not a floral product, or at least not entirely a floral product.

The memento/keepsake is preferably a decorated object. The memento/keepsake can include a ribbon; the memento/keepsake can include the name of the honoring acquaintance placed on the ribbon.

The memento/keepsake can include a name of the honoring acquaintance.

The memento/keepsake can include a name of the deceased person.

The memento/keepsake can include a name of the charity.

The delivery service providers can be located in spaced apart locations, such as in different cities or in different countries. Preferably, at least some of the delivery service providers are florists.

Preferably, the mementos/keepsakes are displayed in a common location at the funeral service; preferably, the common location is a display and the mementos/keepsakes are attached to the display.

The mementos/keepsakes preferably carry inscribed information. The mementos/keepsakes preferably indicate the name of the honoring acquaintance. The mementos/keepsakes preferably indicate the name of the charity. The mementos/keepsakes preferably indicate the name of the deceased person.

The delivery service provider preferably includes a vending machine that receives a payment from the honoring acquaintance and dispenses the memorial gift product to the honoring acquaintance and wherein in step “c” the donation is part of the payment to the vending machine.

Preferably, one of the delivery service providers of step “a” facilitates a transfer of the donation to the charity. Preferably, one of the delivery service providers sends the donation to the charity.

Preferably, at least one of the delivery services providers has an internet website and the purchaser uses said website. Preferably the purchaser orders the donation using the website. Preferably the purchaser orders the memento/keepsake using the website.

Preferably, the memento/keepsake includes the name of the purchaser placed on the ribbon.

Preferably, the donation acknowledgment mementos/keepsakes are attached to a display. The donation acknowledgment mementos/keepsakes can be delivered by a funeral home. The donation acknowledgment mementos/keepsakes can be pins.

Preferably, the donor pays a fee, in addition to the donation, to the provider of the donation acknowledgment mementos/keepsakes.

Preferably, the donation acknowledgment memento/keepsake is displayed with like donation acknowledgment mementos/keepsakes.

The memento/keepsake can indicate a range of donation amount.

A preferred embodiment of the present invention includes a method of marketing a memento/keepsake to an honoring acquaintance that desires to honor a deceased person, preferably comprising the steps of:

a) providing one or more delivery service providers that enable delivery of the memento/keepsake to a funeral service of the deceased person at a funeral service location;

b) enabling the honoring acquaintance to place an order for the memento/keepsake, said order including a price that is paid by the honoring acquaintance;

c) wherein the price in step “b” includes a donation to a charity; and

d) wherein the price in step “b” includes the service of delivery of a memento/keepsake that is delivered by one of the delivery service providers of step “a” to the location of step “a”.

Another preferred embodiment of the present invention includes a method of marketing a memento/keepsake, preferably comprising the steps of:

a) providing a network of delivery service providers that enable delivery of the memento/keepsake to a funeral service for a deceased person at a selected funeral service location;

b) enabling a purchaser to place an order for the memento/keepsake, the order including a price that is paid by the purchaser;

c) wherein the price in step “b” includes an amount of money that is a donation to a charity;

d) wherein the price in step “b” includes the delivery of a memento/keepsake that is delivered by one of the delivery service providers of the network of step “a” to the location of step “a”; and

e) wherein at least a portion of the amount of money of step “c” is paid to the charity.

While the memento/keepsake can be a floral product, preferably it is not a floral product, or at least not entirely a floral product.

The memento/keepsake is preferably a decorated object. The memento/keepsake can include a ribbon; the memento/keepsake can include the name of the honoring acquaintance placed on the ribbon.

The memento/keepsake can include a name of the honoring acquaintance. The memento/keepsake can include a name of the deceased person. The memento/keepsake can include a name of the charity.

The delivery service providers can be located in spaced apart locations, such as in different cities or in different countries. Preferably, at least some of the delivery service providers are florists.

Preferably, the mementos/keepsakes are displayed in a common location at the funeral service; preferably, the common location is a display and the mementos/keepsakes are attached to the display.

The mementos/keepsakes preferably carry inscribed information. The mementos/keepsakes preferably indicate the name of the honoring acquaintance. The mementos/keepsakes preferably indicate the name of the charity. The mementos/keepsakes preferably indicate the name of the deceased person.

The delivery service provider preferably includes a vending machine that receives a payment from the honoring acquaintance and dispenses the memorial gift product to the honoring acquaintance and wherein the donation is part of the payment to the vending machine.

Preferably, one of the delivery service providers facilitates a transfer of the donation to the charity. Preferably, one of the delivery service providers sends the donation to the charity.

Preferably, at least one of the delivery services providers has an internet website and the purchaser uses said website. Preferably the purchaser orders the donation using the website. Preferably the purchaser orders the memento/keepsake using the website.

Preferably, the memento/keepsake includes the name of the purchaser placed on the ribbon.

Preferably, the donation acknowledgment mementos/keepsakes are attached to a display. The donation acknowledgment mementos/keepsakes can be delivered by a funeral home. The donation acknowledgment mementos/keepsakes can be pins.

Preferably, the donor pays a fee, in addition to the donation, to the provider of the donation acknowledgment mementos/keepsakes.

Preferably, the donation acknowledgment memento/keepsake is displayed with like donation acknowledgment mementos/keepsakes.

The memento/keepsake can indicate a range of donation amount.

Another preferred embodiment of the present invention includes a method of facilitating charitable contributions, preferably comprising the steps of:

a) providing a plurality of donation acknowledgment mementos/keepsakes;

b) providing a donation acknowledgment memento/keepsake when a donor makes a contribution;

c) delivering the donation acknowledgment memento/keepsake to a funeral service location where the donation acknowledgment memento/keepsake is displayed,

d) recording the name of the charity, and the amount of the donation;

e) distributing donated funds to the charities.

Another preferred embodiment of the present invention includes a method of facilitating charitable contributions, preferably comprising the steps of:

a) providing a plurality of donation acknowledgment mementos/keepsakes, each donation acknowledgment memento/keepsake including a space for the name of a charity and the name of a donor;

b) providing a donation acknowledgment memento/keepsake when a donor makes a contribution;

c) filling in the name of the charity and the name of the donor;

d) delivering the donation acknowledgment memento/keepsake to a funeral service location where the donation acknowledgment memento/keepsake is displayed;

e) as the donation acknowledgment mementos/keepsakes are distributed, recording the name of the donor, the name of the charity, and the amount of the donation;

f) distributing donated funds to the charities.

Another preferred embodiment of the present invention includes a method of facilitating charitable contributions, preferably comprising the steps of:

a) providing a plurality of donation acknowledgment mementos/keepsakes, each donation acknowledgment memento/keepsake including a unique identifier and space for the name of a charity and the name of a donor;

b) providing a registry of the unique identifiers;

c) providing a donation acknowledgment memento/keepsake when a donor makes a contribution;

d) filling in the name of the charity and the name of the donor;

e) delivering the donation acknowledgment memento/keepsake to a funeral service location where the donation acknowledgment memento/keepsake is displayed;

f) as the donation acknowledgment mementos/keepsakes are distributed, recording in the registry of the unique identifiers the name of the donor, the name of the charity, and the amount of the donation;

g) distributing donated funds to the charities.

Another preferred embodiment of the present invention includes a method of marketing a memento/keepsake, preferably comprising the steps of:

a) providing at least one delivery service provider that enables delivery of the memento/keepsake to a funeral service of the deceased person at a selected funeral service location;

b) enabling a purchaser to place an order for the memento/keepsake through the delivery service provider,

c) said order comprising a price that is paid by the purchaser, a first portion of the price paid including a donation to a charity and a second portion of the price paid including a delivery of a memento/keepsake by the delivery service provider to the selected funeral service location.

Another preferred embodiment of the present invention includes a method for acknowledging a charitable donation in tribute to a decedent preferably comprising the steps of:
a) making a donation to a charitable organization;
b) facilitating a monetary transaction for the donation;
c) representing the donation in a tangible form;
d) facilitating a monetary transaction for the form;
e) supplying the form; and,
f) exhibiting the form at an event memorializing the decedent.

Another preferred embodiment of the present invention includes a method of marketing a charitable gift donation preferably comprising the steps of:

a) providing a database of charitable organizations to an honoring acquaintance wishing to make a charitable donation on behalf of a deceased;

b) facilitating the charitable donation on behalf of the deceased to at least one of the charities in the database of charitable organizations in step “a”; and

c) based on the donation of step “b”, causing a tangible memento/keepsake of the charitable donation to be displayed at a funeral service location for the deceased.

includes an indication of the identity of the honoring acquaintance making the donation of step “b” along with an indication of the identity of the charity to which the donation of step “b” is made.

Another preferred embodiment of the present invention includes a method for marketing a charitable gift donation preferably comprising the steps of:

a) providing a database of charitable organizations to an honoring acquaintance wishing to make a charitable donation on behalf of a deceased;

b) facilitating a charitable donation on behalf of the deceased to at least one of the charities in the database of charitable organizations in step “a”; and

c) based on the donation of step “b”, causing a memento/keepsake of the charitable donation to be displayed on an electronic display, on a hologram, on ice, or other non-permanent display at a funeral service location during a funeral service for the deceased.

Another preferred embodiment of the present invention includes a method of marketing a memento/keepsake to an honoring acquaintance desiring to honor a deceased person, preferably comprising the steps of:

a) providing one or more delivery service providers that enable delivery of the memento/keepsake to the funeral service of the deceased person at a funeral service location;

b) enabling the honoring acquaintance to place an order for the memorial gift, said order including a price that is paid by the honoring acquaintance to a delivery service provider of step “a”;

c) wherein the price in step “b” includes a donation to a charity;

d) wherein the price in step “b” includes the service of delivery of a memento/keepsake that is delivered by one of the delivery service providers of step “a” to the funeral service location of step “a”; and

e) wherein the price in step “b” includes the service of the delivery service provider conveying the donation to the charity.

Another preferred embodiment of the present invention includes a method of marketing a memento/keepsake, preferably comprising the steps of:

a) providing a network of delivery service providers that enable delivery of the memento/keepsake to a funeral service of the deceased person at a selected funeral service location;

b) enabling a purchaser to place an order for the memento/keepsake, said order including a price that is paid by the purchaser;

c) wherein the price in step “b” includes an amount of money that is a donation to a charity;

d) wherein the price in step “b” includes the service of a delivery of a memento/keepsake that is delivered by one of the delivery service providers of the network of step “a” to the funeral service location of step “a”; and

e) wherein the amount of money of step “c” is paid to the charity.

The donation acknowledgment mementos/keepsakes can be pins or ornaments.

The donor may be required to pay a fee, in addition to the donation, to the provider of the donation acknowledgment mementos/keepsakes. The donation acknowledgment memento/keepsake is preferably displayed with like donation acknowledgment mementos/keepsakes.

The funeral service location is where a funeral service is taking place.

Preferably, the donation is made in honor of the deceased.

Another preferred embodiment of the present invention includes a method of facilitating honoring a deceased person, preferably comprising the following steps:

(a) (i) facilitating a donation to a charity or (ii) accepting a donation on behalf of a charity;

(b) (i) facilitating delivery of a memento/keepsake to a funeral service location of the deceased person at a funeral service location so that the memento/keepsake may be displayed before the conclusion of the funeral service, or (ii) delivering a memento/keepsake to a funeral service of the deceased person at a funeral service location so that the memento/keepsake may be displayed before the conclusion of the funeral service, the memento/keepsake being a tangible representation of the donation.

The charity can accept the donation on behalf of itself and facilitating delivery of the memento/keepsake can include instructing a delivery service to make the delivery.

The donor can deliver the memento/keepsake himself.

A funeral home can facilitate the donation to the charity.

The charity can facilitate delivery by enabling the donor to receive the memento/keepsake prior to the funeral service.

The memento/keepsake is preferably displayed before the beginning of the funeral service.

The donor can receive the memento/keepsake and hire a delivery service to deliver the memento/keepsake, and facilitating delivery of a memento/keepsake to a funeral service location can include giving the memento/keepsake to the donor.

Facilitating delivery of a memento/keepsake to a funeral service location can include hiring a delivery service such as Federal Express, UPS, the US Postal Service, Airborne Express, to deliver the memento/keepsake.

A vending machine that receives a payment from the donor can dispense the memento/keepsake to the donor.

The donation can be part of the payment to the vending machine.

Another preferred embodiment of the present invention includes a method of facilitating honoring a deceased person, preferably comprising the following steps:

(a) (i) facilitating a donation to a charity, or
(ii) accepting a donation on behalf of a charity, or
(iii) confirming that a donation to a charity has been made, or
(iv) receiving a representation that a donation to a charity has been made; and

(b) (i) facilitating delivery of a memento/keepsake to a funeral service of the deceased person at a funeral service location so that the memento/keepsake may be displayed before the conclusion of the funeral service, or
(ii) delivering the memento/keepsake to a funeral service of the deceased person at a funeral service location so that the memento/keepsake may be displayed before the conclusion of the funeral service,
   the memento/keepsake being a tangible representation of the donation.

The delivery of the memento/keepsake can be facilitated by (i) confirming that a donation to a charity has been made or (ii) making a representation that a donation to a charity has been made.

Another preferred embodiment of the present invention includes a method of facilitating honoring a deceased person, preferably comprising the following steps:

(a) advertising or otherwise making known availability of a service to deliver a memento/keepsake which is a tangible representation of a charitable donation; and

(b) (i) facilitating delivery of the memento/keepsake to a funeral service of the deceased person at a funeral service location so that the memento/keepsake may be displayed before the conclusion of the funeral service, or
(ii) delivering the memento/keepsake to a funeral service of the deceased person at a funeral service location so that the memento/keepsake may be displayed before the conclusion of the funeral service.

The memento/keepsake can have the donation information thereon or attached thereto, though preferably thereon.

Preferably, mention of the service of the present invention is made in an obituary or obituaries.

Another preferred embodiment of the present invention includes a method of facilitating honoring a deceased person, preferably comprising the following steps:

(a) communicating with a charitable donor; and

(b) facilitating delivery of a memento/keepsake which is recognized by a great number of persons to be a tangible representation of a charitable donation to a funeral service of the deceased person at a funeral service location so that the memento/keepsake may be displayed before the conclusion of the funeral service.

Another preferred embodiment of the present invention includes a method of facilitating honoring a deceased person, preferably comprising the following steps:

(a) receiving instructions to deliver a memento/keepsake which is recognized by a great number of persons to be a tangible representation of a charitable donation; and

(b) delivering the memento/keepsake to a funeral service of the deceased person at a funeral service location so that the memento/keepsake may be displayed before the conclusion of the funeral service.

Another preferred embodiment of the present invention includes a method of facilitating honoring a deceased person, preferably comprising the following steps:

(a) receiving instructions to deliver a memento/keepsake which is a tangible representation of a charitable donation, the memento/keepsake having thereon or attached thereto a donation confirmation number, the donation confirmation number being a unique identifier representing that a charitable donation has been made; and

(b) delivering the memento/keepsake to a funeral service of the deceased person at a funeral service location so that the memento/keepsake may be displayed before the conclusion of the funeral service and/or to a representative of the deceased person.

Preferably, the donation confirmation number allows one to confirm that a charitable donation has been made.

The price for the charitable donation and the delivery and other processing charges can paid in two or more transactions.

Another preferred embodiment of the present invention includes a method of facilitating honoring a deceased person, preferably comprising the following steps:

(a) advertising or otherwise making known availability of a service to deliver a memento/keepsake to a funeral service of the deceased person at a funeral service location so that the memento/keepsake may be displayed before the conclusion of the funeral service; and

(b) (i) facilitating delivery of the memento/keepsake to a funeral service of the deceased person at a funeral service location so that the memento/keepsake may be displayed before the conclusion of the funeral service, or
(ii) delivering the memento/keepsake to a funeral service location of the deceased person at a funeral service location so that the memento/keepsake may be displayed before the conclusion of the funeral service.

Preferably, the memento/keepsake is displayed before the beginning of the funeral service.

Preferably, the memento/keepsake is representative of a charitable donation made in honor of the deceased.

Preferably, the memento/keepsake has thereon or attached thereto a name of the honoring person and a name of the deceased.

Preferably, the memento/keepsake has thereon or attached thereto a donation confirmation number, the donation confirmation number being a unique identifier representing that a charitable donation has been made.

Preferably, the memento/keepsake has thereon or attached thereto a name of the honoring person, a name of the deceased, and a name of a charity to which the donation is made.

Preferably, the memento/keepsake includes information or identifying material or names, wherein the information or identifying material or names can be provided by engraving or printing a clear label on a printer.

Another preferred embodiment of the present invention includes a method of facilitating honoring a deceased person, comprising the steps of:

(a) providing a website with:

(i) a list of obituaries;

(ii) a list of charities;

(iii) a list of florists;

(iv) information about a memento/keepsake which is a representation of a donation made to a charity by a user of the website in honor of a deceased person;

(b) facilitating a donation to one of the charities on the list;

(c) facilitating contact between a user of the website and a florist on the list to allow the user to order the florist to deliver a memento/keepsake to a funeral service location prior to the conclusion of a funeral service of the deceased person.

Preferably, the charity is on the list of charities.

Preferably, the list of florists is of florists nationwide. Preferably, the list of florists is of florists worldwide. Preferably, the website indicates the proximity of the florists on the list to the funeral service location. Preferably, the user can choose a florist of his choice.

Preferably, the user can view the obituaries on the list.

Optionally, the charity list is from an IRS database.

Another preferred embodiment of the present invention includes a method of honoring a deceased person, comprising the steps of:

(a) making a donation to a charity in honor of the deceased person;

(b) causing a memento/keepsake which is a representation of the donation to be delivered to a funeral service location prior to the conclusion of a funeral service of the deceased person. Preferably, the donor is assisted by an entity or entities which perform the following steps:

(a) (i) facilitating the donation or (ii) accepting the donation on behalf of the charity;

(b) (i) facilitating delivery of the memento/keepsake to the funeral service of the deceased person at the funeral service location so that the memento/keepsake may be displayed before the conclusion of the funeral service, or (ii) delivering the memento/keepsake to the funeral service of the deceased person at the funeral service location so that the memento/keepsake may be displayed before the conclusion of the funeral service, the memento/keepsake being a tangible representation of the donation. The charity can accept the donation on behalf of itself and facilitating delivery of the memento/keepsake can include instructing a delivery service to make the delivery.

The donor can deliver the memento/keepsake himself.

A funeral home can facilitate the donation to the charity.

The charity can facilitate delivery by enabling the donor to receive the memento/keepsake prior to the funeral service.

The donor can receive the memento/keepsake and hire a delivery service to deliver the memento/keepsake, and facilitating delivery of a memento/keepsake to a funeral service includes giving the memento/keepsake to the donor.

Facilitating delivery of a memento/keepsake to a funeral service can include hiring a delivery service such as Federal Express, UPS, the US Postal Service, Airborne Express, to deliver the memento/keepsake

The donation to the charity can be made via a website of the charity and a website of a delivery service can be used to cause the memento/keepsake to be delivered.

Preferably, a single website is visited to make the donation to the charity and to cause the memento/keepsake to be delivered.

On the website of the charity there can be a link to the website of a delivery service provider which delivers the memento/keepsake.

On the website of a delivery service provider which delivers the memento/keepsake there can be a link to the website of the charity.

Preferably, the memento/keepsake is substantially non-perishable. Even more preferably, the memento/keepsake is non-perishable. The memento/keepsake can be, for example, aluminum with a finish to make the memento/keepsake resemble polished brass. The memento/keepsake can have a label made of paper with a finish to make paper resemble polished brass.

At least one of the facilitations can occur via the internet or similar electronic means, via toll free telephone number, via local telephone number, via long distance telephone number, via faxes, via e-mail orders, or similar electronic means.

Payment can be made by credit card, debit card, e-check, or other methods of non-cash payment.

Preferably, at least one of the following products is sold to a family member or other representative of the deceased: display apparatus from the group consisting of shadow boxes, shadow frames, display fabrics, storage boxes, easels, Rolodex™/carousel type displays, scrapbook/photo type display, and combinations thereof.

Preferably, the shape of the memento/keepsake is a trademark for tangible representations of donations made in honor of deceased persons. Preferably, in substantially all transactions, the shape of memento/keepsake is a trademark for tangible representations of donations made in honor of deceased persons. Preferably, in all transactions, the shape of memento/keepsake is a trademark for tangible representations of donations made in honor of deceased persons.

Preferably, the memento/keepsake includes thereon or attached thereto a trademark for tangible representations of donations made in honor of deceased persons.

Preferably, in substantially all transactions, the memento/keepsake includes thereon or attached thereto a trademark for tangible representations of donations made in honor of deceased persons. Even more preferably, in all transactions, the memento/keepsake includes thereon or attached thereto a trademark for tangible representations of donations made in honor of deceased persons.

The memento/keepsake is preferably displayed at the time of the funeral service.

Preferably, the memento/keepsake is durable, non-paper, and includes thereon or attached thereto a name of the donor, a name of the deceased, and the name of the charity. In such a case, preferably, there is a trademark on the memento/keepsake or attached thereto in a type size larger than the type size of the name of the donor, the name of the deceased, and the name of the charity, and there is a donation confirmation number on memento/keepsake or attached thereto in a type size smaller than the type size of the name of the donor, the name of the deceased, and the name of the charity.

A card can accompany the memento/keepsake.

The charity can facilitate delivery by enabling the donor to receive the memento/keepsake prior to the funeral service by giving the memento/keepsake to the donor and/or sending the memento/keepsake to the donor via a delivery service, and the donor can deliver the memento/keepsake to the funeral service of the deceased person.

Another preferred embodiment of the present invention includes a method of facilitating honoring a deceased person, preferably comprising the following steps:

(a) receiving instructions to deliver a memento/keepsake which is a tangible representation of a charitable donation, the memento/keepsake having thereon or attached thereto a donation confirmation number, the donation confirmation number being a unique identifier representing that a charitable donation has been made; and

(b) causing the memento/keepsake to be delivered to a funeral service of the deceased person at a funeral service location so that the memento/keepsake may be displayed before the conclusion of the funeral service and/or given to a representative of the deceased person.

Preferably, the donation confirmation number allows one to confirm that a charitable donation has been made. The donation confirmation number can be a code including letters and other characters as well as numbers.

The memento/keepsake can be delivered to the donor, who can deliver the memento/keepsake to a funeral service and/or to a representative of the deceased person.

A kiosk can be used to facilitate at least one of the donation and the delivery.

A receipt can be issued for tax exempt status of the donation. The receipt can be issued to the donor.

Another preferred embodiment of the present invention includes a method of facilitating honoring a deceased person, preferably comprising the following steps:

(a) providing a web site or like electronic location with a plurality of obituaries thereon or a plurality of links to obituaries thereon;

(b) providing a link on the web site to a web site or web sites of an entity or entities which perform the following steps:
(1) (i) facilitating a donation to a charity, or
   (ii) accepting a donation on behalf of a charity, or
   (iii) confirming that a donation to a charity has been made, or
   (iv) receiving a representation that a donation to a charity has been made; and
(2) (i) facilitating delivery of a memento/keepsake to a funeral service of the deceased person at a funeral service location so that the memento/keepsake may be displayed before the conclusion of the funeral service, or
   (ii) delivering the memento/keepsake to a funeral service of the deceased person at a funeral service location so that the memento/keepsake may be displayed before the conclusion of the funeral service,

the memento/keepsake being a tangible representation of the donation.

One can sell to the surviving family or other representative of the deceased display products from the group consisting of shadow boxes, shadow frames, book-type displays, folding book-type displays, tree displays (real or artificial) for hanging keepsakes in the shape of ornaments, display fabrics, storage boxes, easels, Rolodex™/carousel type displays, scrapbook/photo type display, and combinations thereof. These products are preferably customized for use with the program of the present invention.

A donor might be required to enroll in a membership program to participate in the method. The family or other representative of the deceased might be required to enroll in a membership program to participate in the method. A fee can be charged to enroll in the program. The fee can be charged to the family or other representative of the deceased. The fee can be charged to the donor. The fee can be charged by a funeral planner. The fee can be charged by a funeral home.

The memento/keepsake can have information thereon or attached thereto. The information can include the name of the deceased. The information can include the name of the charity. The information can include the name of the donor. The information can include a code which confirms that a donation was made.

Another preferred embodiment of the present invention includes a method of facilitating display at a funeral service of a deceased person at a funeral service location of a memento/keepsake which represents a donation made in honor of the deceased person, wherein a plurality of like mementos/keepsakes are displayed on a display apparatus, preferably comprising the following steps:

(a) (i) receiving, directly or through another, a donation in honor of the deceased person or facilitating the donation in honor of the deceased person, or
(ii) receiving a representation that the donation has been made;

(b) (i) facilitating delivery of the memento/keepsake to the funeral service of the deceased person at the funeral service location so that the memento/keepsake may be displayed before the conclusion of the funeral service, or
(ii) delivering the memento/keepsake to the funeral service of the deceased person at the funeral service location so that the memento/keepsake may be displayed before the conclusion of the funeral service.

The memento/keepsake is preferably displayed before the beginning of the funeral service. The memento/keepsake is preferably representative of a charitable donation made in honor of the deceased.

Preferably, a plurality of the mementos/keepsakes are displayed on a display board or other display apparatus.

Delivery of the memento/keepsake can be facilitated by sending an e-card.

The memento/keepsake can be a card.

Preferably, the memento/keepsake is durable.

Preferably, the memento/keepsake comprises metal.

Identifying information can be placed on the memento/keepsake with a clear label printed on a computer printer.

The donation can be facilitated by a link to a web site. The web site can be at least one from the group consisting of a web site of a charity, a web site of a gift merchant, a web site of a donation processor, a website of a delivery service provider, a website of an administrator of a program using a method of the present invention.

The delivery of the memento/keepsake can be facilitated by a link to a web site. The web site can be at least one from the group consisting of a web site of a charity, a web site of a gift merchant, a web site of a donation processor, a website of a delivery service provider, a website of an administrator of a program using the method.

If the donor indicates the name of the deceased, the charity to which the donation is to be made, the total amount which the donor wishes to spend, including all fees in addition to the donation received by the charity, all processing fees and the amount of the donation can be determined automatically. A computer program can determine all processing fees and the amount of the donation.

The donor can donate to a charity, receive a donation confirmation number, and communicate the donation confirmation number to the memento/keepsake provider.

Gift certificates to use the program of the present invention can be provided.

The delivery of the memento/keepsake can be facilitated by providing a link to a delivery service provider on the website of a charity.

There can be a donate button on a web site.

The mementos/keepsakes are preferably displayed in a common location at the funeral service. For example, the common location can be a display and the mementos/keepsakes can be attached to the display.

The memento/keepsake can include a personalized message selected by the honoring acquaintance.

The memento/keepsake can include an indication of the amount of the charitable donation.

The memento/keepsake can include an indication of the identity of the honoring acquaintance making the donation. The memento/keepsake can include an indication of the identity of the charity to which the donation is made.

The display, such as a display board, on which a plurality of the keepsakes are displayed can be offered to a loved one of the person whose funeral service is being held.

Another preferred embodiment of the present invention includes a method of marketing a memorial gift product to an acquaintance of a deceased person, preferably comprising the steps of:

a) providing one or more delivery service providers, said providers enabling delivery to a funeral service location of the memorial gift;

b) enabling the acquaintance to place an order with the delivery service provider of step “a” for the memorial gift, said order including a price that is paid by the acquaintance to the delivery service provider of step “a”;

c) the acquaintance making a donation to a charity in honor of the deceased person;

d) wherein the price in step “b” includes the service of delivery of a memento/keepsake that is delivered by one of the delivery service providers of step “a” to the funeral service location of step “a”, said memento/keepsake including information about the donation of step “c”;

e) wherein before step “d” the delivery service provider is made aware of the donation of step “c”; and

f) facilitating the display of multiple mementos/keepsakes like the memento/keepsake of step “d” on a common display at the funeral service of the deceased person.

The delivery service provider can contract with another for delivery of the memorial gift.

The donation can be paid to the delivery service provider.

The donation can be paid by the delivery service provider to the charity.

The acquaintance can place the order using a telephone. The acquaintance can place the order using a computer. The acquaintance can places the order using the internet; in such a case, the acquaintance can places the order using an internet web site of the delivery service provider.

The acquaintance can make the donation using an internet web site of the delivery service provider. The acquaintance can makes the donation using an internet web site of the delivery service provider. The acquaintance can make the donation using a telephone. The acquaintance can makes the donation using a computer.

The funeral service can be a funeral. The funeral service can be a memorial service wherein there is no body to be buried or cremated. The funeral service can be a funeral alternative. The funeral service can be a wake.

Preferably, the memento/keepsake is delivered to the funeral service location prior to the beginning of the funeral service of the deceased person.

The funeral service is preferably at least one from the group consisting of a funeral, a memorial service, a wake, and a funeral alternative held shortly after the death or discovery of the death or the presumption or declaration of the death of a person.

Preferably, the funeral service is held up to two months after the death or discovery of the death or the presumption or declaration of the death of the deceased person. More preferably, the funeral service is held less than a month after the death or discovery of the death or the presumption or declaration of the death of the deceased person. Even more preferably, the funeral service is held less than two weeks after the death or discovery of the death or the presumption or declaration of the death of the deceased person. Most preferably, the funeral service is held less than one week after the death or discovery of the death or the presumption or declaration of the death of the deceased person.

One charge can be made for the charitable donation and a separate charge can be made for the cost of the tangible memento/keepsake and its delivery.

The price can be paid in two or more transactions.

The memento/keepsake can be displayed on an electronic display, on a hologram, on ice, or other non-permanent display at a funeral service location during a funeral service for the deceased.

Other preferred embodiments of the present invention include systems for carrying out the methods of the present invention.

It is believed by the inventor that this approach to “in lieu of flowers” and/or requests that a donation be made in honor of a deceased person/thing, will encourage more people to follow through with their intentions to make a donation because of the convenience of making a donation, the fact that their donation will be symbolically represented and displayed with a beautiful keepsake/memento at the time the funeral service is conducted, and that the keepsake will be a preferably permanent memento to commemorate the life and memory of the deceased.

The method of the present invention for making/facilitating, symbolically representing and displaying a memorial donation tribute “in lieu of” or in addition to flowers and other memorial gifts at the time of a funeral service places it on equal footing with floral arrangements in terms of it also being a tangible token of compassion and respect that can be beautifully displayed during and, because of its beauty and preferably durable nature, subsequent to the funeral service. As with floral gifts present at a funeral service, the mere number of them will also act as a more realistic representation of the love and respect others held for the deceased and their families. Without the method of the present invention, the relative emptiness of a funeral parlor or a funeral service locale suggests otherwise and unnecessarily adds to the somberness of an already depressing situation. The method also allows the surviving family or other loved ones the opportunity to express their gratitude for the donation to the donor at the funeral service.

The method of the present invention is preferably represented by a keepsake/memento (e.g. an ornament, pin or other type keepsake/memento of a selected shape (e.g. heart)) that can preferably display selected information. The optionally displayed information can include one or more of, for example: the name of the deceased, the name of the donor, the name of the charity to which a donation is made, a unique identifier or “DCN” (donation confirmation number). A donation confirmation number or other unique identifier could be introduced as a step in the method of the present invention. The DCN could be a confirmation number unique to each transaction that confirms a transaction has been received and successfully processed. The DCN will preferably verify that a bona fide donation was made that could then allow the donor to purchase the representative keepsake so that it could be displayed at the time of the funeral service. The keepsake/memento DCN slogan could be, “The Symbol of Integrity”. It is expected that the public will identify the preferred method of the present invention as one that represents the highest standard of integrity when correlating the keepsake/memento with a charitable donation tribute. It is believed that the general public will come to substantially and universally recognize the preferably trademarked keepsake/memento with a genuine act of philanthropy in honor of a deceased person or thing, such as a pet. The DCN could be analogous to a Certificate of Authentication one receives upon purchase of original artwork. All transactions will preferably be encrypted employing a Secure Sockets Layer (SSL) such as that offered by VeriSign Secure®. The actual amount of the donation might not be revealed. The information could be inscribed on the keepsake or attached thereto in various fashions to the keepsake. For example, a computerized engraving machine, as is used in many mall-based engraving gift stores such as the “Things Remembered®” franchise, could be used to engrave information in the afore-mentioned categories. Because the machine would be able to maintain specific settings customized to the method of the present invention, each memento or keepsake could easily be engraved in a few minutes. The optionally displayed information might also be recorded by writing, typing, printing, calligraphy or other means of inscribing information.

This keepsake/memento (e.g. a heart-shaped keepsake/memento) is preferably placed on display at the funeral service. Such a display could be, for example, a fabric-covered and draped type of display placed on an easel next to the casket or urn or any place where a funeral service is being held. The personalized keepsakes could be placed on the display as they are for example, purchased from the funeral home, delivered by florists or other participating entities (e.g. delivery service providers), or by individual mourners themselves.

The keepsake/memento could have one or more types of fixation apparatus such as adhesive, pins, hooks, hook-and-loop fastening material, magnets, and/or other fasteners/applicators/adherence techniques or be partly filigree so that it could facilitate something being passed through it, similar in function to an eyehole, so that they could easily be affixed or placed on the display. Keepsakes/mementos could be 0.5 inch (0.27 cm) wide by 0.5 inch (0.27 cm) tall to 2 feet (61 cm) wide by 2 feet (61 cm) tall; for example, they can be about 3″ (7.6 cm) by about 4″ (10 cm). Displays could be available in various shapes or they could be available in only one universally recognized shape. Displays could be available in various sizes depending on the anticipated number of mourners (for example, the display could be rectangular in shape and anywhere from 5″ (13 cm) wide by 7″ (18 cm) tall to 4 feet (123 cm) wide by 5 feet (152 cm) tall, and could be for example about 20″ (51 cm) wide by 30″ (76 cm) tall. A tree could even be used as a display. Each display could accommodate a multiplicity of keepsakes with the ability to size up or down so that the display does not seem too empty or too crowded. Such a display could be available in various fabrics so as to try to portray the personality of the deceased or preference of the surviving family (by family, I mean those close to the deceased, whether related by blood, marriage, civil contract, or long personal association). For example, there could be separate displays designed for infants, children, adults, hobby oriented persons, philosophically oriented persons, etc. The display could also be designed with a single fabric so that the fabric will act as a trademark for the program of a preferred embodiment of the present invention.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view illustrating a step of the preferred method of the present invention showing an exhibited display and keepsakes/mementos displayed thereon;

FIG. 2 is a perspective frontal view illustrating a step of the method of the present invention showing a keepsake/memento and related donation information;

FIG. 3 is a perspective view illustrating an optional product of the present invention, namely a shadow box display of the present invention;

FIG. 4 is a front view illustrating a step of the method of the present invention showing an example of a keepsake/memento;

FIG. 5 shows a pin which can be used in a method of the present invention;

FIGS. 6-8 are schematic flow chart diagrams showing some examples of the preferred methods of the present invention;

FIG. 9 is a perspective view illustrating a step of a preferred method of the present invention showing an exhibited display and keepsakes/mementos displayed thereon;

FIG. 10 is a front view illustrating a step of the method of the present invention showing an example of a keepsake/memento;

FIG. 11 is a perspective view illustrating an optional product of the present invention, namely a shadow box frame of the present invention

FIG. 12 is a front view illustrating an optional product of the present invention showing an example of a keepsake/memento for use in a Rolodex-type display;

FIG. 13 is a perspective view illustrating an optional product of the present invention, namely a folding book-type display album of the present invention;

FIG. 14 is a front view illustrating a step of the method of the present invention showing an example of a keepsake/memento attached by ribbon to a card;

FIG. 15 is a front view illustrating a step of the method of the present invention showing an example of a keepsake/memento with identifier insert;

FIG. 16 is a front view illustrating a step of the method of the present invention showing an example of a card type/locket type keepsake/memento;

FIG. 17 is a front view illustrating a step of the method of the present invention showing an example of a keepsake/memento; and

FIG. 18 is a perspective view illustrating a step of the method of the present invention showing an example of a person adding a keepsake/memento to a display.

### DETAILED DESCRIPTION OF THE INVENTION

It is believed by the present inventor that the innovative and aesthetically beautiful keepsakes/mementos of a preferred method of the present invention will fill the void the absence of floral arrangements creates when requests for donations are made and each keepsake/memento representing a donation tribute 10 placed on the display 20 will soon have the same association of love and respect that the more traditional gifts had.

It is believed that those making the contribution will be gratified and proud to have their personalized keepsake/memento gift 11 displayed as a permanent memorial to the deceased and those maintaining possession of and/or displaying the collection of keepsake/mementos 11 will find a sense of comfort and pride from it as well. Preferably, the method of the present invention will include the issue a preferably durable keepsake/memento 11 to be beautifully displayed in acknowledgment of the charitable donation 19 made in honor of someone or something (such as a pet) that will eliminate the public's negative perception and sentiment associated with “in lieu of flowers” (or sometimes requesting donations without specifically using “in lieu of” phraseology) requests for donations and the lack of floral arrangements present at the time a funeral service 21 is being held.

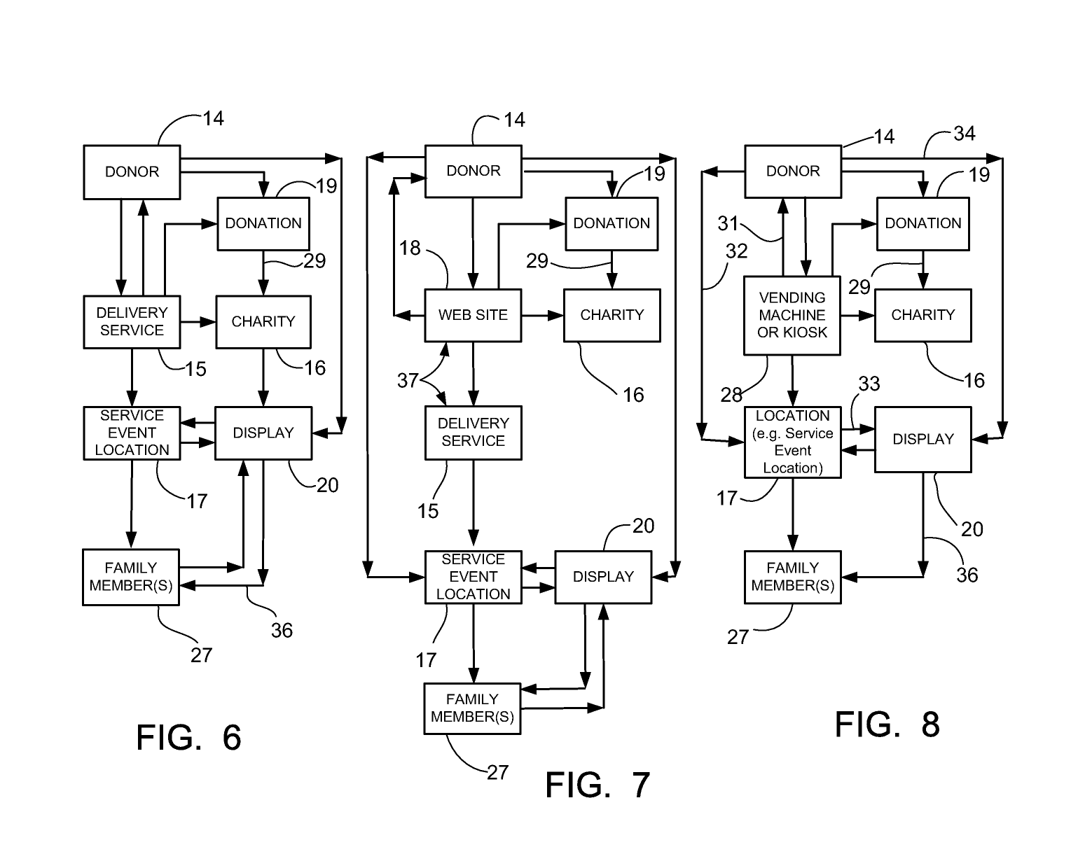

A preferred embodiment of the present invention provides a method of facilitating and acknowledging a memorial tribute donation with a representative memorial gift keepsake/memento 10 that is preferably displayed at the time of a funeral service 21 is held and the marketing of such a memorial gift product 10 to a family member, friend, acquaintance or other entity 14 wishing to honor a deceased person. The gift product preferably has two components: 1) a donation 19 and 2) a tangible keepsake or memento 11 representative of the donation. The methods of some of the preferred embodiments of the present invention (see FIGS. 6-8) provides one or more delivery service providers 15 that enable delivery of the donation tribute 10 as represented by memorial gift/keepsake/memento 11 to the funeral service 21 held in honor of the deceased person at a selected location 17 such as a funeral home, church, park or any other designated place. The delivery service providers 15 can be part of a network and/or referred through a web site 18, toll-free number, telephone number, fax, e-mail, order forms or other means of disseminating or advertising such information.

In FIGS. 6-8, DONOR 14 can be a donor or donors, and could include, for example, an acquaintance, friend, family member, company, or organization who/which wishes or desires to honor a deceased person; DELIVERY SERVICE 15 can be, for example, a delivery service, such as a florist, a donation processor, gift merchants, retailers, UPS, FedEx, DHL, USPS and/or a keepsake merchant 38; SERVICE/EVENT LOCATION 17 can be a funeral home or other location where a funeral service in honor of a deceased person is taking place; FAMILY MEMBER(S) 27 can be a family member or family members, a close friend or friends of the deceased, or someone else with a relationship to the deceased akin to a family member by birth or marriage or anyone selected to receive custody of the keepsake/memento 11; WEBSITE 18 can be, for example, the website or other collection of electronic information and/or assets belonging to or existing for the benefit of a user or users of a preferred method of the present invention, a donation processor, a keepsake merchant, gift merchant, funeral home, funeral planner, or a delivery service network such as Teleflora, FTD, Hallmark, UPS, FedEx, DHL, or USPS; VENDING MACHINE OR KIOSK 28 can be an automated donation processor, a manned kiosk or cart such as in a shopping mall or airport, a keepsake merchant 38, donation processor or a delivery service network device accessible by a donor 14 at any convenient location, such as at an airport, florist or funeral home.

A preferred method of the present invention enables family, friends, acquaintances, companies, corporations or other donor 14 to place an order for a donation tribute 10, the order including a price that is paid by family, friends, acquaintances or other donor 14. This price could include the dollar value of the donation 19, and/or the price of the keepsake/memento 11 and all other charges associated with the processing and delivery of the keepsake/memento 11, if applicable, that is delivered by one of the delivery service providers 15 to the funeral service location 17 or purchased at a point-of-sale retail location where the donor 14 may choose to receive the keepsake/memento 11 and personally deliver it to the funeral service location or to their preferred person 27 or location 17 (see FIGS. 5 and 18).

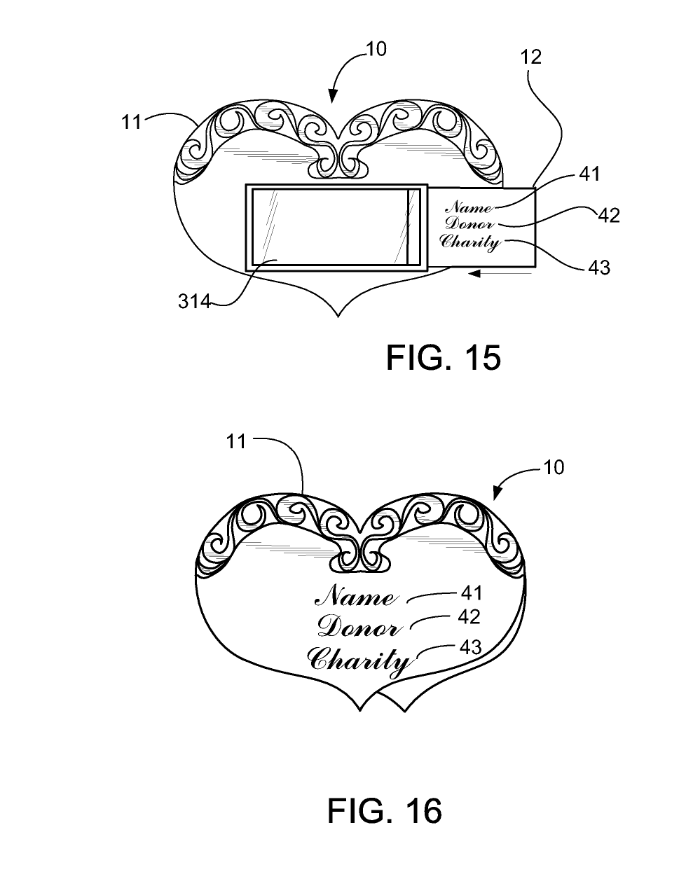

In a preferred method, the memorial gift product 10 includes a memento/keepsake 11 that is not entirely, or at all, a floral product. In the preferred method, the memorial gift 10 is a memento/keepsake 11 that is a decorated object. The memento/keepsake 11 can be of a selected shape. The keepsake/memento 11 can include a ribbon 22 (see FIG. 14). The keepsake/memento 11 can include recorded matter such as the name 42 of the person that is donating (see FIGS. 2, 10, 12, 14-17). The keepsake/memento 11 can include information that is placed on a card 12 that is part of the keepsake/memento 11 (see FIGS. 2 and 15). The card 12 could be detached to give to the family/friend/other 27 while the keepsake 11 could be placed on the display 20 or the card could remain as part of the displayed keepsake 11. In the preferred method of the present invention, the donation tribute keepsake merchants 38 and delivery service providers 15 can be located in spaced-apart locations such as a network of merchants and/or delivery service providers that are located in different cities, different states or different countries. Some of the delivery service providers 15 can be florists. In the preferred method, the memorial gift product 10, memento or keepsake 11 is placed in a common area such as on a display 20. The keepsake/memento 11 can indicate specific information such as the card 12 in FIG. 2 that which carries the name 41 of the deceased, the name 42 of the family member/friend/acquaintance/other (donor 14), the name 43 of the charity 16 to which the donation was made, or unique identifier (such as a DCN) or other information 44. As used herein, charity 16 denotes any person, organization, cause, or legal entity to which a donation 19 is made and includes the connotation of “charity” which can be found in U.S. Pat. No. 5,696,366, dated 9 Dec. 1997, column 8, line 46 through column 9, line 60 (IRS codes can vary based on an organization's structural makeup and mission. Code assignments also indicate whether or not donations made to organization's assigned code are tax-exempt. For example, IRS Codes 501(c) (3) (donations made in the 501(c) (3) code are all tax-exempt); 509(a) (1) through 509(a) (4), 509(a); 4942(j) (3); 501(c) (4); 501(c) (6)).

The present invention could provide a method or various methods of facilitating donations 19. For example, donations 19 could be processed through 1) a step in the method of the present invention and/or 2) in conjunction with the method of the present invention (for example donation processors/gift merchants) or 3) independent of the method of the present invention (for example when a donor makes a donation directly to a charity or donation processor and subsequently purchases a representative keepsake/memento). Donations 19 could be processed, for example, through a donation processor such as the JustGive organization, or any legal entity in good standing that routinely performs donation processing (e.g. PayPal, NetworkforGood, Click & Pledge). New entities could be created to process donations 19 in accordance with a preferred method of the present invention and/or could cooperate with other entities participating in the method of the invention. A database of IRS-recognized charities 16 could be provided through the method of the present invention. Use of an existing database developed by Guidestar of over one and a half million IRS recognized charities 16 (obtained from IRS Business Master File) could be incorporated as a step in the method of the present invention or in conjunction with the method of the present invention by forming a relationship with Guidestar and/or other organizations with similar databases. Guidestar, Philanthropic Research, Inc., is a non-profit organization founded in 1994 to increase philanthropy worldwide. Donations 19 could also be processed by dealing directly with individual charities 16, and/or downloading donation/keepsake order forms that could be faxed or mailed. A donor 14 may also wish to make a donation 19 independent of a donation facilitator of a preferred method of the present invention and subsequently purchase a representative donation keepsake/memento 11 of a preferred method of the present invention, most preferably upon providing confirmation, such as a DCN, that a donation 19 was indeed made. This would serve to safeguard the integrity of one of the methods of the present invention. A preferred method of the present invention can include the distributing of the donated funds 29 to a charity or charities 16 at a selected time, such as upon completion of processing a donation 19, after the funeral service 21 is concluded or other specified reasonable and/or contractually agreed upon time period.

A donor 14 could also log on to a website 18 (FIG. 7), for example, the website 18 of a user of a preferred method of the present invention, which could have a running/current national obituary database. The donor 14 could key in the name 41 and address (for example the city and state where the deceased resided) of the deceased and the obituary and/or other information could display. The donor 14 could key in the amount of money 19 they wished to donate to the requested or donor's choice of charity 16, and the program could do the rest, for example, deduct the administrative fees, cost of the keepsake/memento 11, delivery charges, process and forward 29 the remainder of the donation 19 to the charity 16, forward the request for the keepsake/memento 11 to a keepsake merchant(s) 38 who could personalize and deliver the keepsake 11, issue an itemized receipt for the donor's records and tax purposes, maintain a log of donations, etc. This could also be offered as a membership-based web site including single use visitation. Members could preferably be assigned a pass code, password, and/or other unique user identifiers to identify the user and/or their account and/or to access information on the site. Account information could be saved for members that could serve to expedite their future transactions. Membership could be free, a fee could be charged, and/or there may be fees associated with particular services. The convenience of “one-stop-shopping” and “one-site-shopping” is a highly desirable offering in today's fast-paced society.

The preferred method includes providing a plurality of donor acknowledgment keepsake/mementos 11. The method includes providing a donation acknowledgment 10 wherein a donor 14 makes a contribution or donation 19 to a charity 16. A donation tribute acknowledgment keepsake/memento 11 is then preferably delivered as part of the method to a location 17 where the donation acknowledgment keepsake/memento 11 is displayed (and/or kept, if after the funeral service 21). The method can include recording on the keepsake/memento 11 for example, the name 41 of the deceased, the name 42 of the donor(s) 14, the name 43 of the charity(ies) 16, the DCN (donation confirmation number). Donation amounts 19 may or may not be revealed. Donation amounts 19 could be bracketed and reflected by varying the materials, style and/or composition of the keepsake/memento 11. For example, donation amounts 19 could be bracketed as follows; $5-25; $26-75; $76-100; $101-150; $151-225; $226-300; etc. For example, if the keepsake/memento 11 was designed as a heart, tiny hearts could be added to denote increasing bracket amounts. For example, in the first bracket, no additional hearts would be present; the second bracketed amount would have one additional miniature heart; the 3rd bracketed amount would have two additional miniature hearts, etc.

A preferred method of the present invention would offer an efficient and convenient “one-stop-shopping” method, for making a donation tribute 10 to honor a deceased person/thing and hence encourage compliance with requests for donations 19 and/or a personal choice to express condolence and respect through philanthropy. Additionally, a preferred method of the present invention would further encourage a donation tribute 10 by preferably having it timely acknowledged and represented by a keepsake/memento 11 that is preferably publicly displayed at the time a funeral service 21 is held (see FIG. 18). As people now make it a point to see what arrangement was sent to the service on their behalf by a florist, they will likely also want to see their donation representative keepsake/memento as it expresses their respect for the decedent and condolence to the surviving family during one of their most difficult times, usually immediately following the death of their loved one. Having the knowledge that their memorial donation will be represented by a beautiful keepsake that will be displayed at the time of the funeral service, will likely also persuade the general public not to put off the intention of making a donation tribute but instead to quickly execute it. The incentive provided by a preferred method of the present invention to act in a timely fashion is expected to increase the overall number of donation tributes made that will also likely correlate to an increase in the total dollar amounts given to charitable causes.

In FIG. 7, upon learning, reading or otherwise being made aware of the death of a person, an individual (donor 14) could contact the funeral home/funeral planner, florist or other entity 23 participating in the method of the present invention. Such individual could request that a specified amount of money 19 be donated to a charity 16 in the name 41 of a deceased person or thing (such as a pet).

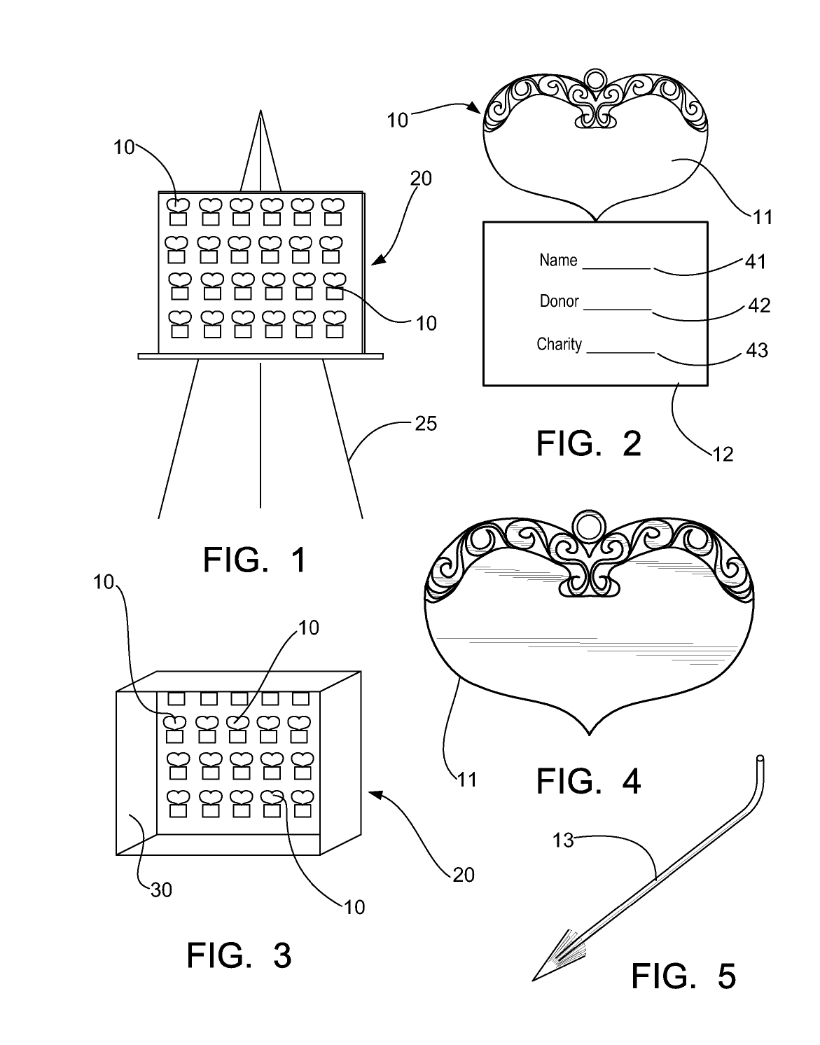

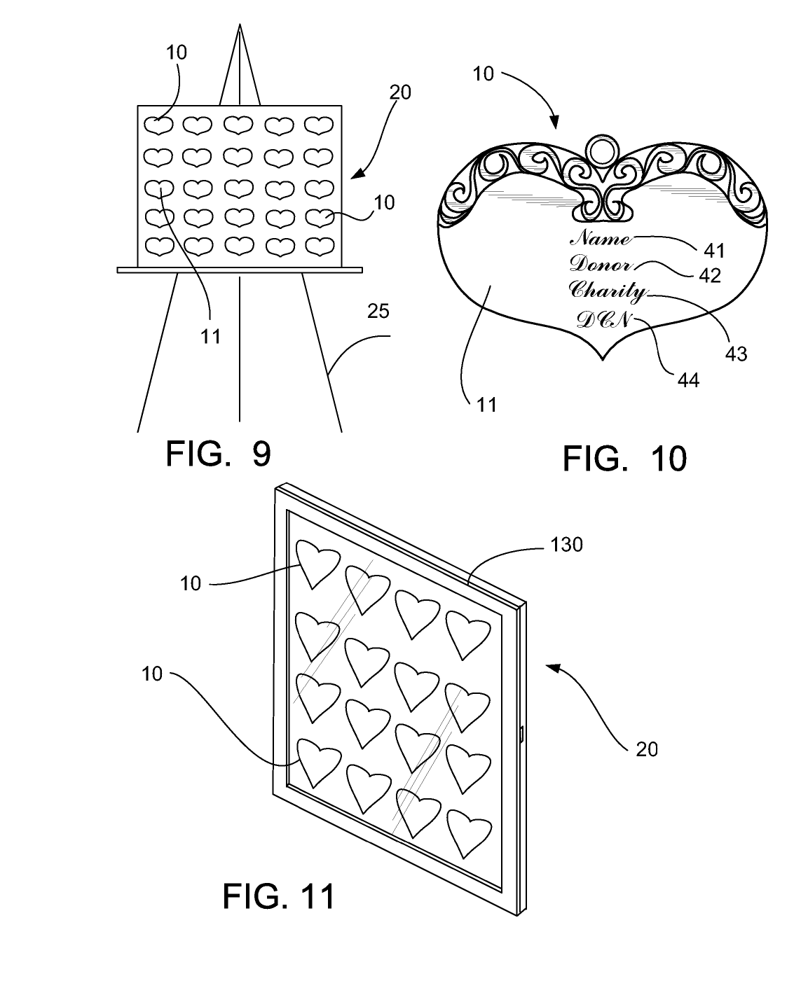

The participating entity 23 in the method of the present invention could be, for example, a funeral service location 17, a florist, a funeral home, gift merchant, retailers, a church, a charity and could function as a donation processor and/or keepsake merchant 38 and/or delivery service provider 15 and process this request by obtaining billing and, if applicable, delivery information as well as the name 41 of the deceased, name 43 of the charity(ies) 16 to which the donation 19 is being made and name 42 of the donor or donors 14 which could then be written, typed, printed, engraved, labeled, or otherwise inscribed on a suitable medium (e.g. a label or card) or directly onto the keepsake/memento 11 itself. The information 41, 42, 43, 44 that is preferably recorded (on card 12, for example) could be attached, affixed, fastened by ribbon or other suitable method of fixation to keepsake/memento 11 (see FIGS. 1, 2, 4 and 9-16) and/or on to the keepsake/memento 11 itself. The keepsake/memento 11 could be made of a type of metal, for example, brass, polished-brass, tin, nickel, brushed nickel, alloys, aluminum, sterling silver, pewter, gold, gold-plated, or other suitable metals and/or materials such as plastic, paper, cardboard, ceramic, glass, cloisonne, natural materials (such as stone, wood), man-made synthetics, etc. The keepsake/memento 11 could also be electronically generated at the time of the funeral service such as by or through a PowerPoint™ or other type of electronic presentation, a hologram, an e-card as well as digitally generated such as by a video, DVD, photography, etc. The designated amount of the donation 19 along with the administrative fees associated with the handling of the request, the cost of the keepsake 11 and charge for delivery, if applicable, along with other pertinent information, such as billing, could then be secured by an acceptable method of payment such as credit card, debit card, e-check, cash, check, check card, money order, cashiers check or other legal present or future acceptable methods of payment. Transactions via the Internet would preferably be protected by recognized authentication and encryption software, for example, VeriSign Secured or other SSL (Secure Sockets Layer). Information required to assure proper billing could also be obtained as it applies to the standard practice of conducting commerce today as well as any future methods.

The keepsake/memento 11, with its optional personalized information 41, 42, 43, 44 which could then be engraved, labeled or otherwise inscribed directly onto the keepsake/memento 11 and/or attached thereto such as with an information card 12, could then be brought to the location 17 where the deceased person/thing is being honored, waked, interred or otherwise remembered and placed on a display 20 (see FIG. 18). The display 20 could be covered in material selected from various fabrics, leather or other suitable materials. The display 20 could be provided by, rented, or offered for sale from the funeral service location 17, by other entities 23 participating in the method of the present invention, or purchased from, e.g. keepsake merchant 38. Other products manufactured, assembled, constructed or otherwise customized for the method of the present invention could also be offered for sale, such as shadowbox 30, shadowbox frame 130, folding book-type display 230 or easel 25.

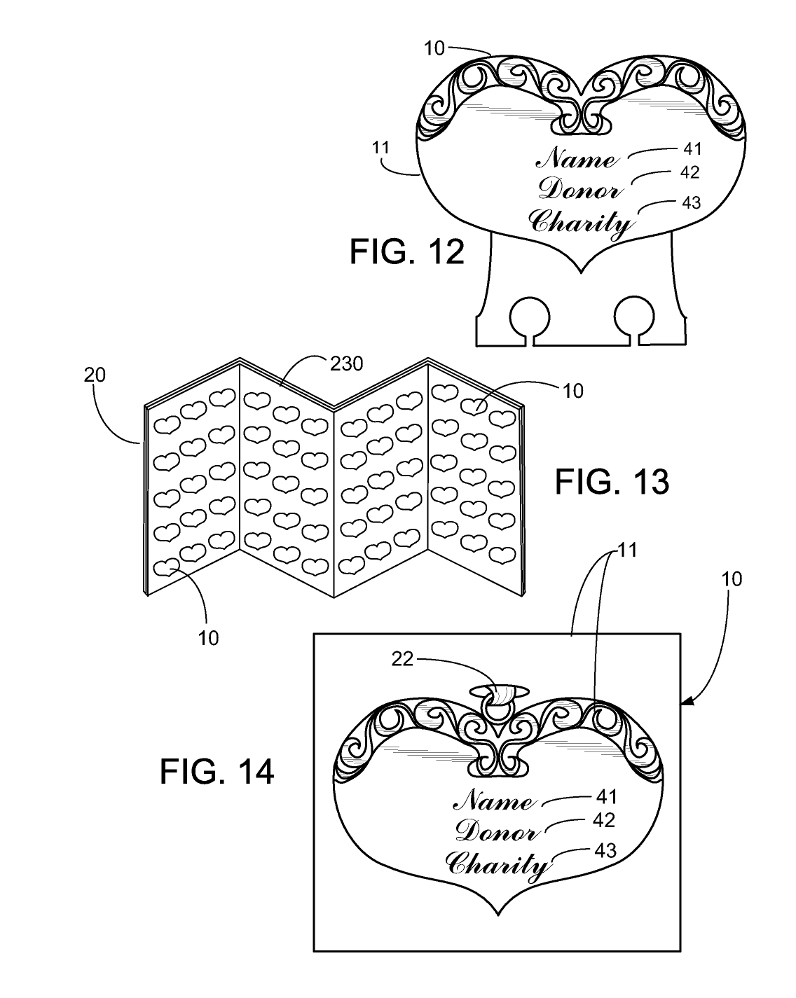

Upon completion of the service, the family members 27 or other person(s) responsible for the services or chosen to receive the display 20, would preferably receive the display 20 (see arrow 36, FIGS. 7-9) and have the option of purchasing items offered for sale in the product line of a preferred method of the present invention to house, protect, store and/or display the keepsakes, for example: a display case such as a type of shadowbox 30 or shadowbox frame 130, a collapsing or folding book-type display 230 (FIG. 13) (although it is pictured as a quad folding type display, it could be a bi-folding, tri, quad or any suitable variation), book-type display such as is the case for photo albums, Rolodex™ or carousel-type display (suitable for receiving keepsakes/mementos 11 as shown in FIG. 12), tree-type display, album 230 or scrapbook type display, ornate storage box (keepsakes/mementos 11 could be photographed and transferred to CD's with customized storage cases) and other product options that could be pictured in a catalog, website, or brochure specifically designed for a preferred method of the present invention. Personalization of the customized products could also be offered. The person or persons 27 receiving the display 20 may choose to take the display 20 home, have the display 20 buried with the deceased, send it to the selected charity or charities 16, take a picture of it to bury with the deceased, or any other personal preference he/she/they may have. Those entities 15, 17, 23, 38 participating in the method of the present invention could be offered the option of purchasing the products customized for the method of the present invention at wholesale cost so that they may retail them to interested parties (e.g. donor 14 or family member 27). The optional products could also be available only through users of a preferred method of the present invention. Having a line of (preferably trademarked) products specifically designed for the donation tribute keepsakes/mementos 11 of a preferred method of the present invention, would help establish and maintain quality control. Also, by having one trademarked style exclusive to the representative donation tribute 10 keepsake/memento 11, it could be universally recognized as a product representative of a preferred method of the present invention that has established the integrity necessary to earn the trust of the consumer/public. It is believed that the integrity of a preferred method of the present invention lies in the public's knowing that when they see a keepsake/memento 11 from a user of a preferred method of the present invention that indeed a donation 19 tribute was made in honor of a decedent. This could most preferably deter others from trying to sell a keepsake/memento 11 without a consumer making a memorial donation tribute 19 in honor of a deceased person or thing. The inscribing of a DCN 44 (donor or donation or payment confirmation number or unique identifier) on the keepsake/memento 11 could also help in establishing a preferred method of the present invention as a program that ascribes to the highest standard of integrity in assuring the benefactor and receiver of the keepsake/memento 11 that a bona fide donation was indeed made as a memorial tribute to a decedent which could also serve to discourage the scenario in the previous sentence from occurring.

Upon choosing to participate in a preferred method of the present invention, an entity 23 such as a funeral service location 17, a funeral home, a florist, gift/keepsake merchant, retailer, a delivery service provider 15, or other entity 38 could be required to sign a legal contract that specifies how the program works and the parameters under which they would preferably function. Such a contract, preferably identifying the protocol, terms, fee for service, and all other pertinent and legal information could serve to safeguard the integrity of the program. Failure to comply with the terms of the contract could, for example, result in expulsion from the program as well as possible legal recourse and, if warranted, criminal prosecution.

The participating entities in a preferred method of the present invention would preferably receive an orientation that explains the details involved in executing the program. This can be accomplished for example by any or all of the following examples: a representative working with participants; an online tutorial; a tutorial CD or DVD; teleconference; written instructional literature, etc.

To help ensure quality control, those entities 23 participating in the program could be licensed to sell products designed for a preferred method of the present invention and preferably agree to exclusively do so in order to make a preferred method of the present invention a universally recognized program built on a commitment to integrity, philanthropy, compassion and respect. Some of the products which could be sold in accordance with a preferred method of the present invention and could represent the program could include, but are not limited to: the keepsakes/mementos 11, displays 20, display fabrics, storage boxes, shadow boxes 30, shadowbox frames 130, easels 25, Rolodex™/carousel type displays, scrapbook/photo type display, engraving equipment, letterhead stationary of a preferred method of the present invention, envelopes, peel and stick labels, labels, cards, etc. Items in the product line could be supplied and invoiced from regionally located warehouses. Orders could be facilitated, for example, via the Internet, a toll-free telephone number, fax number, phone number, order forms, e-mail, text message, etc.

Quality control over the customized products of the method of the current invention could be assessed at the manufacturing location(s) and from each regionally located warehouse. A client service representative could be available for example, via the toll-free number and the on-line web site. Various methods of shipping could be offered and charged accordingly.

Upon completion of all agreements, entities 23 such as a funeral service location proprietor 17, florist, other participating entities 23 or delivery service providers 15, could be permitted to offer a program of a preferred method of the present invention (“program”) to their clients/customers. When a family member/friend/other 27 goes to the funeral home/memorial planner 23 to make the necessary arrangements and requests that the obituary read, for example, “in lieu of flowers . . . ” or “in memory of the deceased a donation is requested” to a specified or unspecified charity, the funeral service planner 23 (or any other entity involved that is participating in the method of the present invention) would preferably explain the option of participating in the program. The funeral home/planner 23, etc., could charge a fee to enroll the deceased in the program or enrollment may be offered as a free service. If the funeral home/planner is not a participating entity that is able to execute the steps in a preferred method of the present invention, the enrollment information, for example the name, the date of birth and death of the deceased, place of residence, name of charity to which donations are requested to made, etc. would preferably be forwarded to all pertinent and/or participating entities 15, 17, 23, 38. For example, a specific local florist or floral chain could be requested by the family/friend/other 27 making the arrangements and/or the information could go to a general e-mail list of entities 15, 23, 17, 38 participating in the method of the present invention. Disclosure of all fees associated with the program, if applicable, would preferably also be communicated.

If participation in a preferred method of the present invention is selected, it could be incorporated into the published obituary. For example; 1) “ . . . “in lieu of” or in addition to flowers, please acknowledge with a donation to the American Heart Association through the Charitable Tribute Keepsake Program available through Jacob and Son Funeral Home (phone number and/or web site) or to find a list of other businesses participating in the program please visit www.charitabletributekeepsake.net . . . ” 2) “ . . . a donation is requested to St. Joseph's Church through the Charitable Tribute Keepsake Program available at Jacob and Son Funeral Home (phone number and/or web site) or to find a list of others participating in the program please visit www.charitabletributekeepsake.net . . . ,” or 3) “ . . . the family requests a donation be made in honor of . . . through the Charitable Tribute Keepsake Program, www.charitabletributekeepsake.net.”

Such a program that employs a preferred method of the present invention could provide a website 18, for example, www.charitabletribute.net. This website could, for example, explain how the program works, the cost of the keepsake/memento 11 and fee for processing the donation 19, preferably with an explanation that two separate charges could be assessed and each would appear on a statement of a credit card, debit card or electronic check, check card or other methods of payment, a picture of a keepsake/memento 11, a picture of keepsakes/mementos 11 on a display 20 during a funeral service 21, a picture of a display 20 with keepsakes/mementos 11 framed in the shadowbox 30, a picture of a display with keepsakes/mementos 11 framed in the shadowbox frame 130 hanging on a wall and displayed on a coffee table in someone's home, pictures of other products 230 that could protect, display and store keepsakes/mementos 11 customized for a preferred method of the present invention, available personalization for the products and testimonials from several people who used the program.

Concerning the fees, preferably one charge could be for the actual amount of the donation 19. The charge for the donation 19 could preferably be processed through a donation processor with secure encrypted transactions, such as JustGive®, (www.JustGive.org) which is a recognized non-profit organization that advertises that it has access to over 1 million IRS-approved charities nationwide. A business relationship and/or partnership preferably could have already been established with this and/or other like organizations for example, Charity Navigator, Network for Good, Guidestar. The JustGive organization processes all donations $5 and above by charging a 3% fee (charged by most credit card companies) to cover the actual costs of each transaction. It could be that a minimum donation amount could be requested in order to participate in the method of the present invention, for example $5, $10, or $15. Other donation processors such as PayPal could be integrated into the website 18 of the program of a preferred method of the present invention or any entity participating in the method with a donate button or link and/or banner. PayPal collects donations via credit/debit cards and bank accounts only. Fees are charged for PayPal's services and they also maintain detailed transaction records which are available on their website. An entity administering a program of a preferred method of the present invention could also serve as a donation processor as well as execute any or all of the subsequent steps involved in the program.

Each participating entity 23 preferably could have an Internet account with JustGive or other like organization that could be established at the time the contractual paperwork is completed. An individual account could be established in each entity's name where donations 19 could be monitored and reviewed. Entities that are part of a larger corporate structure, such as Teleflora and SCI (Service Corporation International), could also be grouped and identified as such. Each participant in the program would preferably be assigned a password/code that includes an identifier indicating that they are enrolled in a program of a preferred method of the present invention. Preferably, funeral service location 17, florist or other participating entities 15, 23, 38 would act in a fiduciary role for the donor 14 and each would preferably link to, or log onto, a donation processor website, such as JustGive, to ensure the donation transaction is properly protected, processed and tracked. Preferably, the donation processor, such as JustGive, would maintain a history of all donations 19 in each individual account that can be reviewed at any time. This could help serve as a checks-and-balance system when comparing keepsake/memento 11 inventory to the number of forwarded donations 19. An e-mail receipt would preferably be immediately sent to the donor 14 that could be used to confirm the donation was successfully processed and verify the tax exempt status of the donation 19 as well as to the participating entity 15, 17, 23, 38 who processed the donation and/or administered the transaction, an administrator of the program of a preferred method of the present invention (if applicable), and/or any other appropriate entity.

The second charge could be for the cost of the keepsake/memento 11, delivery charge, (if applicable), and administrative fee, (if applicable), that could preferably go directly to the participating entity 15, 17, 23, 38. In order to eliminate the confusion of fuzzy math and the possibility of gouging, a maximum flat administrative fee per donation 19 could preferably be contractually established as opposed to a charge based on a percentage of the amount of the donation 19.

For example, a credit card statement could preferably have one charge in the exact amount of the donation 19 identifying the donation processor, for example JustGive, as the merchant and the other charge could preferably appear for the exact amount for the keepsake 11 and any other applicable charges, if any, identifying for example, Jacob and Son Florist/Funeral Home, as the merchant 38.

A charge for each keepsake/memento 11 and accounting for sale of the keepsakes/mementos 11 could preferably be specified in the contract. Each keepsake/memento 11 could, for example, be labeled with the US postal abbreviation for each state where they would be sold as well as a unique identification number and/or bar code. As each keepsake/memento 11 is sold, they could be accounted for by swiping the bar code through a digital recording device or other specified method of accounting for tracking and tallying the number of keepsakes/mementos 11 sold (this can be as bar codes electronically keep track of inventory at many retail cash registers). The funeral service location 17, delivery service provider 15, florist, keepsake merchant 38 and/or any other entity 23 authorized to participate in the method of the present invention could be required to agree to a specified maximum amount for the administrative fees involved in the “program”. (Program refers to the steps involved in executing a preferred method of the present invention.) If the entity participating in the program is also the donation processor, they will preferably be responsible for ensuring that the monies donated 19 will be forwarded 29 to the designated charities 16. For example, if the donation 19 was processed online, the monies 19 may be electronically transferred directly 29 to the charity 16 or the donation processor may have a specific time period in which the donations 19 are to be forwarded 29 to the designated charity 16. If the participating entity is not the donation processor, it could be responsible for obtaining a type of a verification code 44 (such as a DCN) to ensure that a donation 19 was made prior to processing a request for a donation tribute keepsake/memento 11. This could serve to safeguard the integrity of the program which is to ensure to the highest degree possible that a donation 19 was made in tribute to a deceased person/thing (such as a pet) and could therefore be tangibly represented by a keepsake/memento 11 and preferably displayed at the time a funeral service 21 was being held or at any time subsequent to such funeral service 21.

Another variation of a preferred method of the present invention could be for the donor 14 to log onto a website 18 such as that of the program of a preferred method of the present invention or any other participating entity, for example 15, 17, 23, 38, and after reading information regarding the program including any charges associated with carrying out the steps in a preferred method of the present invention and subsequently choosing to participate in the program, the donor/user could key in information in all required fields, such as all information necessary for billing and the personalizing and delivery of the keepsake/memento 11, select an amount 19 they wish to donate from a list of incremental amounts or they could simply enter the total amount that they wish to spend and the program would perform the functions necessary to, for example, purchase, personalize and deliver the keepsake 11, forward 29 the balance to the selected charity 16, issue a receipt detailing the transactions, etc. This preferred method could have one itemized charge for the donated amount of money 19 that was forwarded to the designated charity 29, one itemized charge for the purchase, personalizing and delivery of the memorial tribute keepsake 11 and all other possible fees associated with processing the request (each charge would be itemized on a statement) or one charge representing the total dollar amount of the transaction. Receipts for the transaction(s) could be forwarded to those principals involved in the transactions. Receipts are necessary documentation when claiming a donation as “tax-exempt” on IRS tax forms.

The above methods could preferably apply when a request for a donation 19 is made to one of the over 1.5 million IRS-listed charities 16 or when a category for a donation 19, such as environmental, humanitarian or wildlife causes, is specified. In addition to the above methods, another procedural method could be employed in the method of the present invention when participation is requested but the charity 16 or other organization is exempt from filing with the IRS and therefore is not nationally listed, such as is the case with some small, local churches, shelters, etc. Small charities 16 with annual incomes of less than $5,000 and religious institutions are not required by the IRS to apply for tax-exemption. This situation could be addressed by sending letters to churches and other filing-exempt not-for-profit organizations to inform them of the program and how they can become IRS-registered and nationally listed with donation processing organizations such as JustGive. This could also be accomplished as an independent venture or a cooperative effort with JustGive and/or other like organizations as it will be of benefit to them as well. A campaign to inform local churches and other non-profit organizations, etc. not listed in a database as to how they could become an IRS recognized and nationally listed charity with donation processors, such as JustGive, could be advantageous to all involved. This could be accomplished as a cooperative effort among participating entities in preferred methods of the present invention or any number of other marketing plans. Regardless of how the strategy is carried out, informing legal charities not registered with the IRS's data bank of tax-exempt charities that it is anticipated that their donations would increase due to the ease and accessibility for donors to make a donation from the lists provided by the myriad donation processors, that they would realize the incentive to do so.

If the entity 16 to which the donation 19 is requested to be made to meets with the IRS's charity filing exemption criteria, for example a church that is also not registered in a database, website and/or not set up to receive electronically processed donations 19, the information obtained to secure the donation transaction could also be transferred/forwarded to preferably local affiliates so that they could establish or add to the existing gift registry in the name 41 of the person the donation tribute 10 is honoring. The procedure for handling a non-listed yet legal local charity 16 could be to set up an electronic account in the deceased person's name 41. This would be like the procedure used when establishing a wedding or other gift registry (there are many web companies hosting gift registry services, for example, JustGive.org, Felicite.com, IDo.com and Traveler's Joy). Such a gift registry could also possibly keep track of other gift products offered for sale in a preferred method of the present invention that had already been purchased so as to prevent duplicate gifts. As donations 19 are made to the designated charity 16 in the name 41 of the deceased, they could be placed in the deceased's registry where they could accrue for a specified period of time. For example, accounts could remain open following the funeral service 21 for a period of 1 to 14 days. This is an issue that could be disclosed in a legal contract relating to a program of a preferred method of the present invention at the time an entity explores participation in the program. It could also be that the person 27 making the arrangements for the funeral service 21 selects the length of time they wish to have the registry open or it could be selected by the individual entity within a specific allotted time frame. For a registry to remain open for much longer periods of time could become too laborious for the entity to administer and keep track of accounting-wise. Once the account is closed, the funeral service location 17, funeral home, delivery service provider, florist 15 or other participating entities 23, 38 could have, for example, 15-30 days (this could also be stipulated in the contractual agreement) in which to forward 29 the charitable funds collected to the designated charity 16. A special checking or other banking account for administering a preferred method of the present invention could be used to keep the funds 19 received from memorial donation tributes 10 separate from the general commercial account of the funeral service location 17, florist, delivery service providers 15 or other participating entity 23, 38. Along with the check or other funds transfer could be a message, such as a written letter, stating that the deceased or their family/friend 27 requested donations 19 to charity 16 “in lieu of” or in addition to flowers and other memorial gifts and that ‘x’ amount of money 19 was collected to honor the memory of the deceased and that the enclosed check or other funds transfer represents the amount collected. A letter could also be sent to the surviving family 27 indicating that a donation 19 totaling $“x” was sent to the designated charity 16. Hopefully, the designated charity 16 would preferably send a thank-you note to the family/friend 27 acknowledging receipt of the donation 19. Also at this time, the family 27 could be notified that the collected keepsake/mementos 11 were ready to be picked up 36 or in the event the family 27 had already taken 36 the keepsake display 20 home, that the additional keepsakes/mementos 11 representing the later donations 19, were now available. Sale of the representative donation tribute keepsakes/mementos 11 would preferably be handled in the same fashion as the other donation tributes 10 methods previously described.

Donation/keepsake requests made following this time period (after the funeral service 21; close of gift registry) could be accomplished as a point-of-sale transaction by referring the intended donor 14 to donation tribute/keepsake retailers 38, delivery service providers 15, funeral service location 17, kiosks 28, courtesy desks or vending machines preferably available at various and specific locations or by any of the other methods previously described (for example, Internet 18, toll-free number, fax, etc). A program in accordance with a preferred method of the present invention could have marketing literature available in a variety of media listing locations where a consumer could find out how the program works, see pictures of the donation tribute keepsake/memento 11 and other products available, and how they could participate in a program of a preferred method of the present invention and/or marketing literature available for general distribution at establishments of all participating entities 23. This information could preferably also be available at a participating entity's website 18. The website 18 would preferably also be able to identify entities 23 participating in the program based on a specifically requested area or region. Anyone wishing to locate an entity such as a florist, delivery service provider 15, funeral service location 17, funeral home, participating in the method of the present invention could preferably simply enter, for example, a zip code or area code and a list containing such would preferably display, for example, the names, addresses, web addresses, websites 18, fax numbers, and/or telephone numbers of the participating retailers 15, 17, 23, 38.

Depending on the location selected, namely those locations with participating entities that have delivery service available versus those that don't (such as kiosk vending machines 28), the donor or person 14 purchasing the keepsake/memento 11 could either deliver 32, 34 the keepsake/memento 11 to the surviving family 27 or other appropriate person responsible for the keepsake/memento display 20 or take advantage 32 of the delivery option 15. Upon receipt of the tardy keepsake/memento 11, the person who has the keepsake/memento 11 display 20 could preferably merely place or otherwise affix it to a display 20, for instance, the shadowbox 30 and place/push/adhere etc. the keepsake/memento 11 into/on the chosen display 20 or other storage method selected. If the number of additional keepsakes/mementos 11 were greater than the originally selected display 20 could reasonably accommodate, it could be exchanged for a larger size, for example, a shadow box 30, 130 or additional shadowboxes could be purchased or other products to protect, display and store could be purchased. Products could also be sized down to accommodate smaller numbers of keepsake/mementos 11.

Upon learning of the death of a relative, friend, business associate, etc., a person 14 would preferably contact the funeral service location 17 or any other entity 15, 23, 38 participating in a preferred method of the present invention stating that they wish to make a donation tribute, purchase the representative donation tribute keepsake/memento 11 and have it delivered to the funeral service location. They could be informed as to how the program works and then be asked for the following information: the name 41 of the deceased, the name 42 of the donor 14, the name 43 of the charity 16 they wish to donate to, the amount 19 they wish to donate, their credit card, debit card or for merchants having the ability to process checks electronically, their check routing and account number, as well as any other method of billing information, their billing and physical address and/or any other information necessary to complete the transaction. Take away 34, pick up 32, or delivery service 15 would preferably be achieved based on the person's choice or manner available from the specific entity 15, 17, 23, 38.

The donation tribute keepsake/memento 11 could then preferably be delivered 32 or taken to the funeral service location 17 where the deceased was being remembered and preferably placed 33 on the keepsake/memento display 20 (see FIG. 18).

The benefits of preferred methods of the present invention for making charitable donation tributes 10 in memory of someone/something are expected to be multifold. It is expected that the actual number of donations 19 to charities 16 will substantially increase because preferred methods of the present invention will encourage the general public to follow through on their well-meaning intentions to make a donation 19 in honor of a deceased person/thing due to the convenience of the “one-stop-shopping” approach to make a donation, purchase the representative keepsake/memento 11, have it personalized, delivered and displayed at the time of the funeral service. Additionally, the philanthropic act will be enhanced by the satisfaction of the donor or donors 14 knowing that the family 27 and all others present at the funeral service 21 are aware of their contribution as is demonstrated by the representative keepsake/memento 11, a preferably permanent, comforting and prideful gift. The donor(s) would likely in most cases also be gratified to see their own gift displayed at the funeral service as is the current practice with floral arrangements.

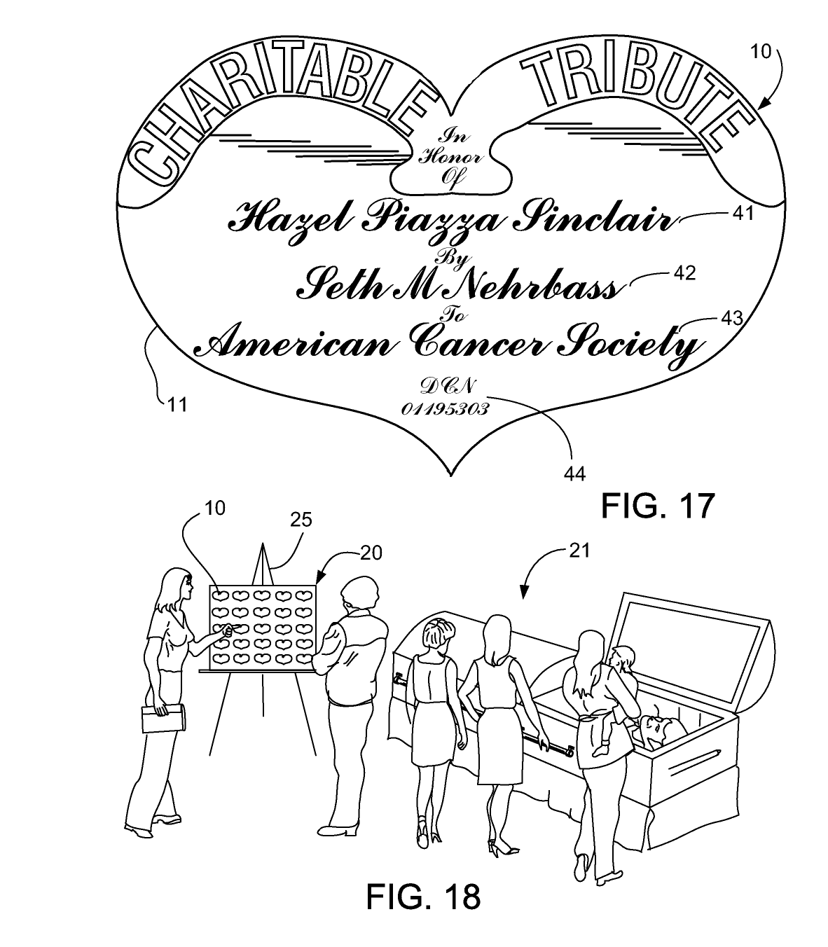

Beyond the ability to match the sentiment of various types of flora and other memorial gifts, the program of preferred methods of the present invention is unparalleled in its longevity to act as a constant reminder to the surviving family and friends 27 of the positive impact their now deceased loved one had on the lives of others. Following the service 21, the family 27 can take 36 the display 20 home or if they so choose, place it in the coffin, send it to a designated charity 16 or any other personal preference. They will preferably also have the option of purchasing other products customized for the program of preferred methods of the present invention to protect, display 20 and/or store the charitable tribute keepsakes/mementos, for example, a shadow box 30 or a shadow box frame 130. The shadowboxes 30 could preferably have the ability to either be hung on a wall or displayed upon a table. Regardless of how they choose to keep the keepsakes/mementos 11, the family/friend/other 27 could have a permanent keepsake/memento 11 commemorating the life of their loved one that could be passed down from generation to generation as a family tribute and heirloom (see FIG. 17).

Without the method of the present invention, a charitable tribute that is made in memory of someone or something loses the utmost effect it was intended to have, to timely demonstrate condolence and respect, hence consoling the surviving family 27 at the funeral service 21, often their greatest time of need.

While there are donation tributes that can be immediately acknowledged, it is typically only via an impersonal, electronic message sent to a surviving family member's computer. Typically, no symbolic representation of the donation 19 is present or displayed as a beautiful and tangible gift at the funeral service 21. During this time of profound grief, it is unlikely that a surviving family member 27 would frequently check their e-mail and if they do, the only record of the honorable deed would be a printable message stating that a donation 19 was made in the name of the deceased. This method of acknowledging a charitable tribute is devoid of personal warmth and also further fails if the intended recipient does not own a computer or have access to e-mail. To the knowledge of the present inventor, there are no current methods of making donation tributes in memory of someone or something that include a beautiful and preferably personalized keepsake/memento gift 11 that acts as the tangible representation of the donation 19 that is displayed at the time of (and perhaps subsequent to) the funeral service 21.

Furthermore, it is often weeks later and sometimes not at all, that a charity without the on-line capability of processing and e-mailing receipt of a donation, acknowledges the receipt of a donation in memory of someone. This type of acknowledgment often comes in the form of a card sent via the postal service. Unfortunately, this acknowledgment method also falls short in achieving its primary function of conveying condolence and heartfelt support for the surviving family 27 at the time the funeral service 21 is held and it is unlikely that such notification cards would be kept in view as the funeral service 21 has long been over nor would it be likely that they would be kept on display 20 at the home of the recipient hence becoming a case of “out of sight, out of mind”.

There are other types of charitable causes that do subsequently mail or display at a substantially later date, tangible items in recognition of receipt of a donation. For example, Plant a Tree, offers a tree ornament (www.northstyle.com) and for each one purchased, a tree is planted to preserve wildlife habitat. Ochsner Hospital in New Orleans, La., offers a brick to pave a walkway at the hospital which can be done as a memorial gift (www.ochsner.org). In order to have a brick personalized, a donation of $100.00 or $250.00 is required. Donations less than this are merely recorded in calligraphy in a leather-bound book in the lobby. Notification is sent to the donor that a donation was received and recorded in the book and a card is sent to the honoree or family of a deceased. Cornell University School of Veterinary Medicine offers an “Honor My Vet” Certificate (www.vet.cornell.edu/fhc/products.htm). A certificate enclosed in a gold-embossed portfolio is sent to a vet stating that a donation was made to the school in their honor from a person in the name of their pet. A minimum $25 donation is required to issue these certificates. All of these occur over various periods of time (usually several weeks or longer following the donation) and none are readily available to display at the time of a funeral service.

Also, certain retail establishments, such as Starbuck's Coffee, occasionally support fund-raising initiatives by having a poster display in the local coffee shops advertising a cause, for example the American Cancer Society. They accept donations from a patron and the patron can write in the name of the person they made the donation in honor of on the single line provided on a cut-out shape of paper, for example a cloverleaf, and the paper can then be taped to a section of the store such as the side of a counter top until the drive is over, at which time the papers are then discarded. All money donated is kept in a separate envelope that is regularly transported by a manager to a local collections center established by the charity sponsoring the fund-raiser.

The American Heritage Dictionary defines donation and tribute as follows: donation 1. The act of giving something to a fund or cause. 2. A gift or grant; contribution; tribute 1. A gift, payment, declaration or other acknowledgment of gratitude, respect, or admiration. Not all donations are made in honor of or in memory of someone or something whereas all tributes are.

There are also many beautiful memorial gifts on the market today, but none of them represent a donation that was made in honor of a deceased person/thing that is displayed with selected information relative to the donation at the time a funeral service is held to honor the decedent.

While methods currently being used to make a donation tribute in honor of a deceased person or thing (such as a pet) undoubtedly represent acts of respect and condolence, they differ from preferred methods of the present invention in that to the knowledge of the present inventor they are not timely represented by a beautiful, tangible gift that is displayed at the time of a funeral service 21. Nonetheless, all charitable tributes do accomplish the goal of enhancing a cause that will hopefully have a positive affect on the future. Family members and friends will likely be proud and find comfort in knowing that the life of their loved one indeed helped to make a difference.

The program of preferred methods of the present invention distinguishes itself by the tangible keepsake/memento gift 10 that represents a donation made in honor of someone/something that is most preferably displayed at the time a funeral service 21 is held. To the knowledge of the present inventor, this method of making/facilitating and/or timely acknowledging and displaying a tribute donation 10 with a beautiful and permanent keepsake/memento 11 gift at the time a funeral/memorial service event 21 is held has never been applied in the funeral, floral, or memorial gift industries.

As it seems that the preferred methods of the present invention have not been identified or explored in any existing industry, it is expected that the preferred methods of the present invention will increase the sales, market share and profit margins to funeral service location proprietors 17, delivery service providers 15 and other participating entities 23, 38.

Also, by displaying the preferably trademarked keepsake/mementos 11 during and subsequent to the funeral service 21 that are expected to be universally recognized as the industry's symbol of integrity by most preferably ensuring that a donation was indeed made as a memorial tribute to a deceased person or thing (such as a pet), it is expected to increase philanthropy awareness worldwide and encourage others to incorporate the program of preferred methods of the present invention into their funeral service 21 plans.

The program of preferred methods of the present invention relates to a method of making donation tributes 10 and the ability to timely acknowledge the donation tribute that is most preferably displayed at the time of the funeral service 21 by means of a preferably trademarked keepsake/memento 11 that could display the name 41 of the deceased, the name 42 of the donor 14, the name 43 of the charity 16, and the DCN (donation confirmation number or unique identifier) 44 in lieu of or in addition to flowers or other gifts to honor the memory of a deceased person or thing, such as a pet. For example, upon learning of the death of a person, an individual could contact the funeral service location 17 or other entity 15, 18, 23, 28, 38 authorized to participate in the program of a preferred method of the present invention and request that a specific amount of money 19 be donated to a specific charity 16 in the name 41 of the deceased person/thing. The donor 14 could then purchase the keepsake/memento 11 and have it delivered 32 or personally take 34 it to the location of the funeral service 21. In the event the donation tribute 10 is made following the public or private funeral service 21, the keepsake 11 could then be taken/delivered to the personally chosen person and/or designated place 27.

The selected authorized entity 15, 17, 18, 23, 28, 38 could process this request by obtaining the name 41 of the deceased, the name 43 of the charity (charities) 16 and the name 42 of the donor (donors) 14 which could then be written, typed, engraved or otherwise inscribed directly on the keepsake 11 or on a card 12, plate or other suitable type of identifier (see FIGS. 15, 17). The identifier could be attached to a keepsake/memento 11 that could be made of various metals such as tin, aluminum, sterling silver, pewter, gold, gold-plated, brass, brass-plated, nickel, brushed nickel, anodized gold, etc. or other suitable natural and/or man-made materials for example, glass, plastic, paper products, cloisonne, ceramic, synthetics, etc., by various methods of fixation, for example, adhesive, ribbon, pin, hook, etc. The designated amount of the donation 19, cost of the keepsake 11, (blank, with recorded information, with an identifier and/or a means of relating a personal sentiment such as card 12, attached or independent of the keepsake), along with the administrative fee associated for the handling of the request, delivery fee (if applicable) could then be secured by a credit card, debit card, check card, electronic check, cash, check, money order, cashier's check or other acceptable method of payment, either currently existing or available in the future.

Following the funeral service 21, another option could be to have the selected information (for example the name 41 of the deceased person or thing, the name 43 of the charity 16, the name 42 of the donor 14, and the DCN) engraved on a metal plate (or other suitable medium and material) or directly onto the keepsake/memento 11 or inserted into or on the keepsake/memento 11 and placed back onto the display 20. For example, an insert 314 similar to that on a luggage tag could be used to house the card 12 or plate (see FIG. 15). Engraving of the selected information would provide a more uniform and formal appearance than could otherwise be achieved from a variety of penmanship styles (see FIG. 17). This feature could preferably only be available through the method of the present invention as are preferably the line of customized keepsake/memento 11 display/storage products in order to preserve its hopefully universally recognizable unique identity, quality and public confidence established through a preferred method of the present invention and its representative, preferably trademarked, keepsake/memento 11. An additional fee for this service may or may not be charged.

In the event the keepsake/memento 11 is made of a material conducive to engraving and the method chosen for inscribing the selected information were engraving, keepsake/memento 11 merchants 38 participating in the program of a preferred method of the present invention could preferably be required to have identical manufacturer and model number engraving machines that could be purchased from an administrator of a preferred method of the present invention and/or from the parent corporations of floral, funeral affiliates or other gift-providing companies or directly from the manufacturer. This could serve to reduce the cost of the machine because of the ability to buy in volume from the manufacturer and, more importantly, ensure continuity of quality and engraving style. An engraving machine could, for example, be a desktop model (such as GoScribe, Gravograph IM4, Gem's “Little Gem”, Roland EGX-20) so as to reduce the amount of space required to accommodate it. This could make it more economically feasible, hence, more alluring for keepsake/memento merchants 38 to add the donation tribute keepsake/memento 11 to their product line. The small amount of space required to accommodate a desk type model could be useful for the sale of donation tribute keepsake/mementos 11 from kiosks 28, courtesy desks and other venues with limited space. Regardless of how someone purchases a donation representative keepsake/memento 11, a highly emphasized point should be to inform the consumer of the desirability of having the selected information that is to be inscribed correct as preferably no refunds will be issued for erroneously supplied information. A bold notice requesting confirmation of the information to be inscribed could appear under the request for this particular information. It could be incumbent upon point-of-sale merchants when dealing directly with consumers to verify the accuracy of the information that is to be inscribed on the donation tribute keepsake/memento 11 prior to personalizing the keepsake/memento 11. If the donation keepsake/memento 11 is made of a metal that could be engraved, a protective film could be placed on the surface that is to be engraved to protect it from scratching or otherwise disfiguring the surface.

As it is most preferable that the keepsake/memento 11 be available at the time of the funeral service, in the event of an engraving machine equipment failure, a “rain check” could be issued so that the keepsake/memento 11 could be engraved at a later date. A note of apology could preferably be on the “rain check” accompanying the keepsake/memento 11 to its designated recipient. The information to be inscribed on the keepsake/memento 11, label or other suitable identifier could then be hand-written, typed, labeled or otherwise inscribed on a donation keepsake/memento card 12, label, etc., and affixed to the keepsake/memento 11, so that it could be displayed at the time of the funeral service. The donation keepsake/memento card 12, label, etc., could have an adhesive back that could be pressed on to the keepsake/memento 11 or other application techniques that will allow for the display of information on the keepsake/memento 11 at the time of the funeral service 21 to honor someone or something without damaging the surface that is to later be engraved.

Another preferred method for displaying information on the donation tribute keepsake/memento 11 could be adhesive or other types of labels that could be printed from a printer (e.g., laser, inkjet or other printing apparatus) and peeled off and placed on the keepsake/memento 11. Color of inks used to print the labels could vary. Labels could be specifically designed for the program of a preferred method of the present invention. Labels could be clear in order to emphasize the selected information or customized labels could be designed in myriad colors. A variety of ink colors could also be used. For example, gold-colored ink on a clear label could look very similar to the appearance of engraving, whereas black ink on a clear label could make the inscription more legible. Like engraving, this method would also serve to keep a sophisticated look and uniform appearance for the keepsakes/mementos 11, however it could be accomplished in a more convenient and economical manner. This method for displaying information could also apply to other forms, shapes and composition the keepsake/memento 11 may have.

Another possible variation of a method of the invention could be to eliminate the engraving of information on the keepsake/memento 11 and allow consumers to write personalized notes instead. Such personal notes may be attached to the keepsake/memento 11 in some fashion such as, though not limited to, a card 12, adhesive sticker, button-type pin, medal-type pin, adhesive card or a card or metal plate slipped into a sleeve 314 similar to that on, although not limited in design to, a luggage tag (see FIG. 15). Securing cards 12 to the keepsake 11 with a ribbon 22 may be another way of personalizing the keepsake/memento 11 (see FIG. 14). It may also be that the keepsake/memento 11 will not have any information or personal notes but instead be a blank keepsake. A card 12, personalized or otherwise, may also be delivered with the blank or other keepsake/memento 11 designs. The keepsake/memento 11 itself could also be a card (see FIG. 16) that could have information inscribed on it as well as a personal sentiment from the donor 14. The keepsake/memento 11 could also be a medal-type pin, button-type pin, or adhesive sticker. If the embodiment of the keepsake/memento 11 were of a card type, the selected information could be displayed on the front and it could open to a personal note from the donor or donors 14 or the personal note could be, for example, on the back cover or any other suitable format and/or combination (see FIGS. 2, 12, 14 and 16). Although the keepsake/memento card embodiment could be beautifully designed, it may not have the association of being a true gift unto itself as some of the other forms are. However, it could be an economical alternative to the other more costly forms of the keepsake/memento.

A participating entity 23 could market the method of a preferred embodiment of the present invention for making a donation tribute 10 in honor of a deceased person/thing (such as a pet) and facilitating the timely acknowledgment with a keepsake/memento 11 that is displayed 20 at the time a public or private funeral service 21 is held to the general public or whomever its customer base comprises. A toll-free number or website 18 or other means of disseminating information could be advertised to receive an explanation of the program and to identify a participating entity or entities 23 in a given area code or zip code, for example.

If a participating entity 23 were a merchant chain, they could also have a website 18 explaining a preferred method of making a memorial donation tribute 10 with its symbolically associated keepsake/memento 11 that is preferably displayed at the time of a funeral service preferably along with other pertinent information that would help consumers decide whether or not to utilize the service/product. For example, a space could be provided where someone could enter or select, for example, a zip code or area code, and the names, addresses (physical and e-mail) and phone numbers of participating entities 23 in that area could display. This site could theoretically be advertising for those entities participating in the program.

The program of a preferred method of the present invention could also have a website 18, toll-free telephone number, fax number, order forms, electronic order forms on a website that could be downloaded, brochures, catalogs and/or any other means of disseminating information where individuals could obtain information regarding the program and those offering the program. Each individual entity participating in the program could also advertise the program, how it works and how to proceed with a preferred method of the present invention.

Many of the courtesy desk locations for donations/keepsake/mementos could be inside a business that has the ability to deliver the keepsake/memento 11, for example a funeral service location 17 or delivery service provider 15 or a florist. Customers using direct, point-of-sale methods to participate in a preferred method of the present invention without the option of a delivery service could immediately receive 31 the keepsake/memento 11 upon completion of all transactions and/or other available service options. This would give a customer the option to either hand carry the keepsake/memento 11 to a funeral service 21 and personally place it on the display 20 (arrow 32, 34) or if it is purchased after the service, to deliver it to their personally preferred person or place 27, for example, the home of the surviving spouse.

A computer program/software/database could be used to offer the consumer a quick and efficient “One-stop-shopping” experience. For example, the program/software/database could be used to process the donation 19 (such as that used by www.JustGive.org), to process the transaction for the keepsake/memento 11, including any ancillary fees associated with the program such as administrative fees and delivery charge (if applicable), forward 29 the donated amount 19 to the named charity or charities 16, send confirmation to the submitting entity, send confirmation to the donor 14 which could also serve to declare tax-exempt or non-exempt donation status, track each transaction, and keepsake inventory. Preferably, a lock could be placed on each transaction so that an entity would not be able to increase its administrative fee beyond the maximum allowed. Each transaction would most preferably have the administrative fee as a fixed amount in hopes of eliminating gouging on the donation 19. It is possible that, for example, a donor 14 could pay a smaller administration fee if dealing directly with a funeral service location 17, as a florist or other off-site entity may need to charge a larger fee to cover deliver charges to the funeral home/funeral service 17 locale or other preferred delivery location 21, 27. The computer program/software could be compatible for a PC, Mac and/or any other computer system offered today or in the future. Preferably, a sequencing lock could be used that could require confirmation of a donation transaction prior to allowing the purchase of a keepsake/memento 11. This would serve to safeguard the integrity of a preferred method of the present invention because the program is most preferably based on being the tangible representation 11 of a memorial donation tribute 10 that is displayed at the time a funeral service 21 is held in honor of someone or something and are likely to be displayed subsequent to the funeral service 21.

Aside from the customary way of doing daily, routine business, the funeral service location 17 and other entities 15, 18, 23, 28, 38 participating in a preferred method of the present invention could have a location on premises similar to that of a customer service desk or a kiosk 28 (electronic and/or manned) where “walk-ins”, “walk-ups” could participate in a preferred method of the present invention by making a donation 19 in honor of someone or something and choose to personally receive 31 the donation acknowledgment keepsake/memento 11 instead of taking advantage of the delivery service option. They would then be able to place the keepsake/memento 11 on the display 20 at the funeral service 21 themselves (arrow 34) or choose to have it placed on the display by someone else (arrows 32, 33) (see FIG. 18).

Another avenue in which participation in the program could be facilitated is through kiosks 28 (electronic and manned). These would preferably be available in places such as shopping malls, airports (to accommodate out-of-state mourners) and other strategically selected locations designed to serve walk-up customers. All donations 10/keepsakes/mementos 11 could be processed here via the same processes previously detailed.

Courtesy desks 28 could be established inside the funeral service location 17 or location of other participating entities 15, 23, 28, 38 to accommodate walk-in customers. A courtesy desk could exclusively handle the donation/keepsake/memento transactions, increasing efficiency by effectively segregating customers wishing to purchase the standard type of goods and services offered by the business establishment.

In FIG. 8, another option that could be available for those wishing to participate in a preferred method of the present invention includes the use of a vending machine 28 (e.g. computerized) containing, for example, keepsakes/mementos 11 with cards 12, or without cards, that could be available in designated locations. A donor 14 could select from a list of specific dollar amounts the amount of money 19 they wished to donate and also choose from a list of charities the charity 16 to which they wished to donate. The computer program could then add the advertised fee for service to the donated amount 19 and a credit card, debit card, check card, e-check information, cash or other acceptable method of payment could be swiped or entered to complete the transaction. The appropriate amount could then be electronically forwarded via secure approved transmission 29 or otherwise sent in accordance with the terms of a contract, to the selected charity 16. The purchase price for the keepsake/memento 11 could be included in the donation transaction or could involve a second step in the process of completing the transactions. Upon successful completion of the transaction for the donation, a donation confirmation number (DCN) could preferably be issued. A donor 14 could key in information such as the name 41 of the deceased, the name 42 of the donor 14, the name 43 of the charity 16, and the machine could engrave the information directly onto the keepsake 11 (see FIGS. 16, 17, 12, 10) (the vending machine 28 could function in a way similar to the vending machines in pet stores that engrave information on pet tags, FAST-TAG™, such as those situated in PetSmart stores) or the keepsake/memento 11 could be blank (see FIGS. 2, 4), have a card 12 attached (see FIG. 15), etc. The vending machine could also print out the selected information on a label that the user could then peel off and adhere to the keepsake/memento 11 form. In any case, the vending machine 28 could then automatically dispense keepsake or memento 11 to donor 14 (arrow 31). As shown in FIG. 18, donor 14 could then bring the keepsake/memento 11 to funeral home or other funeral service locale 17, and place it on to the display themselves or give it to someone who could place it on the display 20, for example an employee of the funeral home as indicated by arrow 32 in FIG. 8. The employee of funeral home 17 could then place the keepsake 11 on display 20 (see arrow 33). Alternatively, donor 14 could place keepsake/memento 11 directly on display 20 (see arrow 34).

Vending machines 28 could be an interactive, e.g. computer-programmed, machine with a list of a number of nationally or internationally known IRS-recognized (or recognized by like organizations in other jurisdictions or regions) charities 16 along with a list of specific dollar amounts for donations 19. The user might also be able to key in the name of a charity if it was not included in the list but registered with the IRS. The user could preferably select a specific charity 16, and a specific dollar amount or be able to key in their preferred donation amount 19. The user could then preferably be shown the dollar amount that will also be charged for the price of the keepsake/memento 11 and processing fee(s), if applicable. The user could then preferably be asked if they wanted to complete the purchase for the total amount of the transaction or change their selections. The user could then preferably be asked if he or she agreed to the terms and dollar amount shown for the transaction. The user could then preferably be asked to swipe their method of payment, for example, credit card, debit card, check card or key in electronic check information or deposit the total sum in cash. Upon acceptance and approval of the method of payment, for example a credit card, the user could preferably be asked to key in the name 41 of the deceased, the name 42 of the donor 14 and the name 43 of the charity 16. An engraving machine could then preferably personalize the keepsake/memento 11 (see FIG. 17) and dispense 31 it upon completion. The vending machine may also inscribe the information onto a label that the user could then affix to the keepsake/memento 11. After dispensing the keepsake/memento 11, a receipt would preferably be issued and/or e-mailed to the user. Once again, two charges could preferably appear on the credit card statement and receipt.

This machine could preferably function in a more complex yet similar fashion as fuel pumps at service stations, snack-type vending machines and pet tag engraving vending machines such as, FAST-TAG™, used at PetSmart stores. The donation amount 19 could preferably be electronically transferred to the donation processor, for example, the JustGive Organization, or the charity 16, directly. The amount charged for the keepsake/memento 11 and processing fee could preferably be electronically transferred to the owners of the vending company, other licensed agent or to the “vending” account of an entity administering the program of a preferred method of the present invention. Cash, if offered as a payment option, would be collected and forwarded or deposited as contracted. The vending machines could preferably be serviced and restocked as is standard in the industry. For example, the vending machine 28 could preferably display the names of a variety of charities 16 to be selected by the donor 14 such as, The American Heart Association, The American Cancer Association, World Wildlife Fund, etc. It could also preferably display a variety of dollar amounts to be selected by the user 14 for donations 19 such as $25, $40, $65, $100, $250, etc. It could also be that selected information to be included on the keepsake/memento 11 could be printed or otherwise inscribed or the keepsake/memento 11 could be blank allowing the donor 14 to personalize it, or a card 12 or other thing accompanying the keepsake/memento 11, themselves.

Another possible way in which a preferred method of the present invention (see FIG. 7) could operate is by licensing an established or existing network 37 of gift delivery providers such as Teleflora, FTD, Inc., 1-800-Flowers, FloraPages.com, Independent Florists, Floral Associations, Hallmark or other entities that typically have broad-based, widespread consumer access and advertising, for example, website 18, toll-free number, fax line, retail outlets, mass media marketing, etc. 18.

Teleflora was founded in 1934 and is the world's leading floral wire service. Teleflora has approximately 30,000 member florists in the US and Canada and nearly 20,000 additional florists they connect to world wide. “Florists' Telegraph Delivery”, FTD, was founded in 1910 as a non-profit corporation. In 1994, it was converted to a for-profit corporation and renamed “Florists' Transworld Delivery”. As of February 2005, FTD stock has been publicly offered on the NYSE under the ticker symbol of “FTD”. FTD is marketed as the largest floral company in the world with its gold “Mercury Man” logo touted as the floral industry's symbol of quality. Currently, FTD has a presence in 154 countries with 20,000 affiliated florists in North America and an international floral delivery network of 50,000. With their recent (Jul. 31, 2006) acquisition of Interflora, FTD's counterpart in the United Kingdom and Ireland, the company is now in a position to expand its presence into other European countries, hence increasing the Company's earnings potential. FTD's Consumer Segment is comprised of FTD.COM, selling products, flowers and specialty gifts, directly to consumers through its Internet web site, www.FTD.COM and its toll free telephone number 1-800-SEND-FTD. This segment continues to see a rise in the number of orders placed as well as increase in the percentage of orders via the Internet. In the Consumer Segment, orders totaled 4,508,000 in 2006 with the majority of these placed via their Internet web site. Total revenue realized by the Consumer Segment for fiscal year 2006 was $275.8 million.

In Company documents filed with the Securities and Exchange Commission is its “Forward-Looking Statement” concerning the Company's outlook, anticipated revenue growth and profitability. It states (excerpted from FTD Group, Inc. Reports Fourth Quarter and Fiscal year 2006 Results), “ . . . the anticipated benefits of the acquisition of Interflora and investments in new products, programs, and offerings; and opportunities and trends within both the domestic and international businesses, including opportunities to expand these businesses and capitalize on growth opportunities or increase penetration of service offerings. The international business will reflect the operations of Interflora Holdings Limited. These forward-looking statements are based on management's current expectations, assumptions, estimates and projections about the Company and the Company's Industry. Investors are cautioned that actual results could differ from those anticipated by the forward-looking statements as a result of the Company's ability to acquire and retain FTD and Interflora members and continued recognition by members of the value of the Company's products and services; the acceptance by new or modified service offerings recently introduced; the Company's ability to sell additional products and services to FTD and Interflora members; the Company's ability to expand existing marketing partnerships and secure new marketing partners within the domestic and international consumer businesses; the success of the Company' marketing campaigns; the ability to retain customers and maintain average order value within the domestic and international consumer businesses; the existence of failures in the Company's computer systems; competition from existing and potential new competitors; levels of discretionary consumer purchases of flowers and specialty gifts; the Company's ability to manage or reduce its level of expenses within both the domestic and international businesses; actual growth rates for the markets in which the Company competes compared with forecasted growth rates; the Company's ability to increase capacity and introduce enhancements to its Web sites; and the Company's ability to integrate Interflora and additional partners or acquisitions, if any are identified.”

The preferred method of the present invention is expected to be recognized as a “new product, program and offerings” that will create opportunities for business expansion and “increase penetration of service offerings” as it is a new method of doing business that, to the knowledge of the present inventor, has never before been offered in the floral, funeral or other gift markets. It is believed that this new concept of making a charitable tribute donation 10 with the ability to have it acknowledged and displayed at the time of a funeral service 21 by a representative keepsake/memento 11 will revolutionize both the funeral and floral industry as well as be economically lucrative to these as well as the gift industry, hence welcomed into their business plans and product lines. To the knowledge of the present inventor, the program of preferred methods of the present invention is a new source of revenue that, until the present invention, has not been identified or explored.

The program of preferred methods of the present invention could involve a step that facilitates the process of making charitable donations 19 and adds new entities to process donations 19. With the method of the present invention, donors 14 world-wide could have their philanthropic acts of condolence, affection and respect beautifully acknowledged and publicly displayed 20 as a keepsake/memento 11 at the time a funeral service 21 is being held to honor someone or something (such as a pet) and the representative keepsake/memento 11 will preferably be a permanent memento to commemorate the life, memory, achievement, etc. of such. It is anticipated that upon introduction of the program of preferred methods of the present invention with its unique method of making and acknowledging a donation tribute 10 in memory of someone or something with a keepsake/memento 11 symbolic of the donation tribute 10 and having it displayed 20 at the time of a funeral service 21, the statistical number of charitable donations 19 will increase, thereby increasing the overall total dollar amount consumers give to charities 16. However, the appropriately timed symbolic representation of the donation tribute 10 in the form of a preferably beautiful and preferably durable keepsake/memento 11 displayed at the time of a funeral service 21 honoring someone or something (such as a pet), the system designed to protect the integrity of the program (DCN) and it all being conveniently and efficiently offered as a “one-stop-shopping” experience for consumers, help to make the program of preferred methods of the present invention unique.

The program of preferred methods of the present invention is very applicable to and needed nowhere more than the floral industry, as it has economically suffered the most from the cultural shift to the “in lieu of flowers” tribute trend. Requests for donations with “in lieu of flowers” phraseology was introduced in 1954 and quickly became the target of a widespread campaign launched by the floral industry to abort or at least curtail this philanthropically imposed economic hardship. The floral industry appealed to funeral directors imploring them to eliminate the damaging “in lieu of flowers” wording to “in memory of the deceased a request is made for donations to . . . ” or other similar language that does not specifically imply that flowers are not to be sent when collaborating on, or writing, the intended publication of the obituary notice. The floral industry's 53 year battle to defeat this upward spiraling trend, resulted in its winning two national public relations awards that encouraged the use of funeral flowers, one in the 1950's and the other in the late 1980's.

Upon review of a sampling of obituary notices on a local, regional and national basis, one can only conclude that the campaign has only been minimally successful. This negative investment of time and money on the part of the floral industry is expected to be replaced with a marketing campaign designed to notify all associates and other entities involved in the industry of the method of the present invention and the positive benefits, economic and otherwise, it offers.

The method of the present invention provides a remedy for the floral industry to recover income currently lost with “in lieu of flowers” and/or “requests for donations” verbiage prevalently appearing in today's funeral planning and obituary notices. Instead of members of the floral industry wincing at obituaries with the words “in lieu of flowers”, they will soon be enthusiastically welcomed as this progressive trend will now be a new source of revenue for them.

Although there are many businesses that have developed ways to offer consumers the ability to increase their charitable gifts both passively (Charity Malls such as www.4charity.com and www.greatergood.com) and actively (www.JustGive.org and Click&Pledge), there is no concept like that of the present invention where one embodiment is utilized to accomplish multiple of the following steps: (1) make a donation tribute 10 in honor of someone or something (such as a pet), (2) have the donation tribute 10 tangibly represented by a beautiful and preferably durable keepsake/memento 11, (3) have selected information inscribed onto and/or attached to the keepsake/memento 11, (4) have the keepsake/memento 11 present and publicly displayed 20 during the time a funeral service 21 is held, (5) have the keepsake/memento 11 serve as a permanent reminder of the love and respect others held for the deceased while commemorating the life of their loved one that could be passed down as a family heirloom, (6) issue a donation confirmation number confirming that a donation 19 was indeed made, hence ensuring the integrity of the program, (7) issue receipts to the principals involved in the transactions and to substantiate tax-exempt status of the donation tribute 10, and 8) track donations and inventory of the keepsake/mementos 11.

Aside from the afore-stated reasons, Teleflora and/or other floral or gift-oriented companies, are likely licensees of the present invention because they have the technological infrastructure, delivery service providers 15, retail merchants, Internet 18 and toll-free phone service, etc. in place to accommodate consumer orders on a national, and in many cases, global scale. FTD Corporation, for example, has an established association with the “Benevolink” program. The FTD website allows consumers to link on to the Benevolink icon that explains their mission; “to bring together consumers, retailers and non-profits to help all reach their respective goals by enabling consumers to direct corporate giving to the causes they see as worthy.” The Benevolink Corporation is a for-profit corporation that generates donations 19 by taking a percentage of sales from individual consumers' purchases from merchants participating in the program and funnels that money to its non-profit 501(c)3 corporation, The Benevolink Foundation. The Foundation in turn shops charities, schools, cultural and religious organizations. Simply put, consumers can generate charitable donations by shopping with retailers participating in the Benevolink program. The program of preferred methods of the present invention could serve as an in-house donation processing facilitation service for FTD and/or other participating entities, or a link could be provided with and/or to other existing donation processors. For example, a “donate now” icon could appear on a web site in conjunction with the program of a preferred method of the present invention. The enticement to use a company participating in the program of preferred methods of the present invention to make a tribute donation 10 in memory of someone is the ability to purchase a keepsake/memento 11 that represents the donation tribute 10 that will preferably be present and preferably displayed at the time a funeral service 21 is held.

A consumer could use the program of a preferred method (see FIG. 7) of the present invention if licensed to FTD or other similar nationwide or worldwide corporation having delivery service provider 15 networks 37, in the following ways. Please note, for the purpose of demonstrating an example of a way that a participating entity could possibly function, the following procedural design has been based upon FTD's website. If using the Internet, a consumer would log on to the website 18 of FTD (or other like floral and/or gift company or like delivery service provider) and under the “Shop by Product” category, or “Other Gift Ideas” category, the program of a preferred method of the present invention could be listed. It could also be under the “Shop by Occasion” “Sympathy and Funeral” category listed as a new item in the “For the Service” product line. The program of a preferred method could also be offered at check-out under “Special Offers” and/or “Promotions.” After selecting the program of a preferred method of the present invention, a home page screen could appear explaining the program of a preferred method of the present invention including transaction security and privacy, legal disclosure and disclaimers, as well as the details that explain the charges involved. For example, it could be stated that two separate charges/transactions may be required. One charge for the amount of the donation 19 could appear as a separate item on their credit card, debit card, check card, electronic check statement (or other acceptable method of payment) with JustGive or other similar organization, or other Internet donation transaction facilitators such as PayPal, as the identified merchant. It is preferable for the user to understand that the actual donation processor could be listed on their credit card statement and not the name of the charity the money was actually donated to. A receipt could preferably be issued to verify that a donation was made that would name the charity designated by the user. New companies could be created specifically designed to process tribute donations 10 through the program of a preferred method of the present invention and in this case the company actually processing the tribute donation 10 could be identified as the merchant on the statement. For example, if a relationship is established with JustGive as the donation processor, a “Donate Now” or “Donate” button/banner could be on the web page which would direct the user/customer/donor 14 to the page 23 of the participating entity (in this case FTD's) on the JustGive website. JustGive charges a 3% fee for the processing and credit card costs that would also be incurred by the entity if it were to process the donation 19 itself via a credit card. The other, or second, charge could be for the cost of the keepsake/memento 11 and processing and/or delivery fees where the transaction recipient could appear as an FTD affiliate (or other point of sale merchant) 17, 23, 38. Appearing on the site under the category of the program of a preferred method of the present invention could be a picture (see FIGS. 1, 9, 18) of a keepsake/memento 11, a display 20 with a multitude of keepsakes/mementos 11 at a service 21, a display 20 in a shadowbox 30, 130 on the wall in a home, other custom designed products 230 to protect, display and store keepsakes 11 as well as testimonials from those who have received the keepsakes 11 and what it meant to them to have a beautifully displayed collection of keepsakes 11 that acts as a permanent record of those who honored their loved one with a donation/tribute 10.

Consumers could also be offered the option of customizing displays 20, display cases and other products offered through the program of a preferred method of the present invention, by selecting, for example, from a variety of materials to cover the displays 20 as well as a variety of frames 30, 130 and other product options available to protect, display and store the keepsakes/mementos 11. This may be treated as a special order or upon request. Prices could vary based on the types of materials selected. Personalization of the optional products could also be offered.

Family members/friends/others 27 may also be offered the option of registering the decedent via a website 18 so that others could purchase memorial/gift tributes 10 in honor of decedent through the steps previously disclosed. A fee may be charged to register a decedent or it may be a free service.

The program of a preferred method of the present invention could have a variety of customized products designed specifically for the program, such as a customized album, that could function like a book-type, Rolodex™ or carousel-type photo album, which could display and protect the keepsakes/mementos 11. Beautifully decorated boxes and other customized items could be offered to protect and store the keepsakes/mementos 11. A catalog showing products customized for the program of a preferred method of the present invention could be available in a variety of forms for all entities participating in the program as well as available to the general public. Images of the keepsakes/mementos 11 could also be digitally stored on CD's with customized labels and other compatible media and saved in cases customized for the program.

The website 18 could then ask the consumer if they wish to proceed with the program. If so, the donation transaction would preferably be required to be completed before one could continue on to purchase the representative keepsake/memento 11. FTD (and/or other like floral and/or gift providing companies as well as an entity administering the program of a preferred the method of the present invention) may choose to develop a 501(c)(3) non-profit company of their own or as a joint venture among them, to facilitate the processing of donations 19 that would function like the JustGive Organization. In the event this in-house donation processing entity is established, the charge incurred to process the donation 19 could then go to it. Fund raising software could also be incorporated into the program of a preferred method of the present invention hosted by such companies as, for example, Kintera, Inc.™, Convio Inc.™, or Get Active™. These companies combine the features of a database, a content management system and customer relationship management software with an all-in-one front end customized for non-profits. Linkshare™ could be incorporated to track transactions. Regardless of how the donation 19 is facilitated and processed, the procedure and fees would preferably be explained in the information provided regarding the program of a preferred method of the present invention. It may also be prudent for these and other floral and/or gift providing companies to pool marketing resources for a campaign to inform as many local charities 16, organizations and institutions, etc. as possible as to the benefits and ease of registering with the JustGive or other like organization in order to increase the number, and hence the total dollar amount, of donations 19 to their causes. Non-profit organizations grossing more than $5000 are required to register with the IRS. Guidestar uses this IRS Business Master File to compile its database. JustGive is one of the many partners Guidestar has that actually process donations 19.

The next screen could request the information necessary to complete the donation transaction. For example, it could ask for the following information; the full name 41 of the person the donation tribute 10 is being made in honor of, the name 43 of the charity 16 or other legally recognized entity to which the donation 19 is being made, the address (or city and state, and/or zip code) of the charity 16, (if some of this information is not known, one could click on to the link provided to acquire the information such as “Guidestar”, “JustGive”, Charity Navigator”, “Network for Good” “Yellow Pages”, “List of Charities”, etc. or a comprehensive book of data/software provided by “Charity Guide” that lists names, address, etc. of charities 16 could be provided to participating entities), the full name 42 of the donor or donors 14, the physical address of the donor 14, the e-mail address of the donor 14, the billing address of the donor 14 if different from the physical address, the amount of the donation 19, the method of payment such as credit or debit card, check card, electronic check (routing and checking account number) or other acceptable form of payment and/or any other information necessary to complete the transaction(s) and ensure that a receipt, electronic or otherwise, is provided to the donor 14 for confirmation of the donation transaction and tax purposes. A space where a donor 14 could type in a personal sentiment that could be included with the keepsake/memento 11 could be provided. A limited number of characters could be designated, for example, a note containing 250 characters. The JustGive website allows a consumer to choose a charity category that serves similar causes in the event the selected charity 16 is not registered or no longer exists. This option could preferably also be offered if FTD and/or other floral and/or gift companies, as well as an entity administering the program of a preferred method of the present invention, choose to form their own charity registries and/or donation processing capability.

There may be a field asking the consumer to recheck the information they typed in for accuracy and if it is correct to click on to the statement, “I have checked and confirm that the information I have provided is correct” or other similar statement that addresses this issue. At this point the consumer could be asked if they are ready to proceed to checkout where the fee for processing the donation 19 and the exact amount of the donation 19 could preferably be itemized and the total dollar amount of the transaction could be displayed. Upon review and acceptance of the information, the consumer could be asked to click on to “Submit” which would complete the donation transaction. A “DCN” 44 could be provided upon completion of the donation transaction. An error message could display if someone were to try to proceed to purchase the keepsake/memento 11 without making a donation.

After completion of the donation transaction, the consumer (donor 14) could be allowed to continue to purchase the representative donation keepsake/memento 11. This could serve to prevent anyone from fraudulently obtaining a keepsake/memento 11 without making a charitable donation 19, as the keepsake/memento 11 is preferably the tangible representation of the charitable tribute donation 19. The following information could be required to process the purchase of the representative donation keepsake/memento 11; (note: as most of the information had already been supplied in the donation transaction, the required fields could be completed by clicking on the displayed information and it could be “auto filled” or if the information were not the same it could allow the user to key in the new information in the required fields) for example, the full name 41 of the person the donation 19 is being made in honor of, the full name 42 of the donor(s) 14; the name 43 of the charity 16 or organization, etc. the donation 19 is being made to; the name and address of the funeral home or other location 17 where the funeral service 21 is being held to honor someone or something (the address to which the keepsake/memento 11 is to be delivered); the method of payment for the cost of the keepsake/memento 11, delivery charges, and/or any other pertinent fees. Appearing in bold lettering at the top of the keepsake/memento 11 transaction page could be a statement advising the consumer that they should be accurate in providing the information for the personalizing of the keepsake/memento 11 as refunds would probably not be issued for incorrectly supplied information. For this reason, there may be a field asking the consumer to recheck what they typed in for the personalizing of the keepsake/memento 11 and if it is accurate to click on to a statement, such as, “I have checked and confirm that I have provided the correct information I wish to have inscribed on the keepsake/memento” or other similar statement that addresses this issue. At this point the consumer could be asked if they are ready to proceed to checkout where the charges for the keepsake/memento 11 and all other associated fees will be itemized and the total dollar amount of the transaction will be displayed. A field might ask if the user wished to use the same method of payment for the keepsake transaction as was used in the donation transaction. Upon review and acceptance of the information, the consumer could click on “Submit” which would complete the remainder of the donation keepsake/memento 11 transaction. The keepsake/memento 11 transaction could be forwarded to a local affiliate (keepsake/memento merchant/inscriber 38) per their current or any future devised routing system so that the keepsake/memento 11 could preferably be personalized and delivered by a local affiliate. The affiliates 38 could be reimbursed per their current payment system or as per a new agreement (financial arrangements, percentages, and/or otherwise) for the program of a preferred method of the present invention. It should be noted that the keepsake/memento 11 could be blank and/or could have a card 12 or other type of method for personalizing the donation representative keepsake/memento 11 gift as well as any of the other keepsake/memento 11 variations previously mentioned or any other shape, form or composition the keepsake/memento 11 may have.

When placing an order via the Internet or toll-free number, the consumer may also have the option of selecting the neighborhood florist they wish to fill their order from a list of local entities 23 participating in the program. This could be done when proceeding to “check out”. Teleflora is currently offering this option in conjunction with deliveries of flowers.

If the program of a preferred method of the present invention were licensed to a floral corporation or other gift providing entity with an advertised toll-free telephone number, a consumer could call the advertised number and request making a donation tribute 10 through the program of a preferred method of the present invention. The company representative could proceed to ask, for example, the caller if they were familiar with how the program works and if not would inform them of such including the two possible sequential transactions, namely one for the donation 19 and the other for the representative donation tribute keepsake/memento 11. This could possibly also be accomplished as one transaction. If a consumer were informed of and agreed to the fees associated with the program such as the cost of the keepsake/memento 11, processing of the donation and/or other fees such as a delivery charge (if any were applicable), it could be that a consumer could simply indicate to the representative the total dollar amount they wished to spend, perhaps over a specified minimum, for example, $35 (US dollars) and the program could deduct any processing or service charges and the cost of the keepsake/memento 11, and the remainder would be the amount of the donation. The consumer could receive an itemized receipt for the transaction that would demonstrate the actual amount of the donation to be used for tax purposes. Although the actual dollar amount for some donations could possibly decrease, it is expected that the program of a preferred method of the present invention will increase the overall volume of donations and hence increase the total amount of dollars donated to charities overall.

The representative could preferably first obtain the required information in order to secure the donation 19 before proceeding to ask for the information needed to purchase the keepsake/memento 11. The representative could advise the caller of the importance of accurately conveying the correct information and spelling for all required information. The caller could then be informed of the “no refund policy” once the representative confirms the information relayed by the caller that would appear on the keepsake/memento 11. (It should be noted that most companies now have a statement, digitally or personally delivered, upon answering a call similar to the “call may be monitored for quality assurance purposes”. This may be of value in the event of a dispute over the accuracy of the information.) The representative could obtain the necessary information from the caller such as the full name 41 of the person being honored by the tribute donation, the full name 42 of the donor(s) 14, the address of the donor(s) 14, the e-mail address of the donor(s) 14, the billing address of the donor(s) 14 if different from the physical address, the name 43 of the charity 16, organization or institution or other entity to which the donation is being made to, the amount of the donation 19, the method of payment such as credit or debit card, electronic check (routing and checking account number), check card or other acceptable form of payment and/or any other information necessary to complete the transaction and ensure that a receipt, electronic or otherwise, is provided to the donor(s) 14 for confirmation of the donation transaction and tax purposes.

If the entity 16 to which the donation 19 is being made is approved and registered by the IRS, the representative could either link on to a donation processor available with a “donate” button that could go to a processor, such as JustGive, or if the entity has its own in-house data base for processing donations, they could simply complete the transactions on their own site. If the entity is not registered, the representative could ask the caller for the city and state or zip code the charity 16 or other organization or institution was located in and they would find the pertinent information required to complete the transaction. The representative could have a variety of ways in which to acquire the information and some of these have been mentioned in the preceding “via the Internet” discussion. Upon successful processing and acceptance of the method of payment, preferably a donation confirmation number could be assigned to the transaction.

Once a donation transaction is completed, the representative could then ask the caller for the information to process the purchase of the representative donation tribute keepsake/memento 10. Since the names 41 of the person being honored, the name 42 of the donor 14 and the name 43 of the charity 16 were already identified in the process of making the donation 19, the name and address of the funeral home or other location 17 to where the keepsake/memento 11 was to be delivered 32 could be all the additional information that could be required. It could also be that the representative could ask if the caller would like to add any personal sentiment to include with/on a/the card. The representative could repeat the spelling of the information that was to be inscribed on the keepsake/memento 11, then ask the caller to confirm if it was correct. If so, the representative could inform the caller of the itemized total cost for the keepsake/memento 11, and/or delivery or other fees associated (if any or applicable) with the keepsake/memento 11 and ask the caller if they would like to use the same method of payment used for the donation transaction. If not, the caller would be asked for the alternative billing information required to complete the keepsake/memento transaction. Following this, the representative could conclude the call with a specified closing reflective of individual company policy such as, “Thanks for shopping with . . . ”

The representative could then forward the keepsake/memento 11 transaction information (this could include a DCN 44) to the local affiliate(s) in the area where a funeral service 21 is being held to honor the deceased person/thing. The information could be forwarded per their current routing system or by any method devised for the successful execution of the program of a preferred method of the present invention transaction so that delivery of the keepsake/memento 11 or consumer pick up 34 of the keepsake/memento 11 could be achieved.

If a consumer elects to go to a retail store, such as a florist, those entities participating in the program of a preferred method of the present invention could preferably have a decal displayed on their storefront door, window and/or other highly visible location advertising the fact that they are authorized to execute the program of a preferred method of the present invention. A picture of a keepsake/memento 11 with the inscribed information could be customized as a logo decal for this purpose to once again distinguish the program of a preferred method of the present invention as a universally recognized symbol of integrity, compassion, respect and philanthropy. The slogan for the universally recognized donation representative keepsake/memento 11 step of the method of the present invention could be, “Honoring the Memory of One Life, For the Benefit of All Life” and the slogan to distinguish its “DCN” could be, “The Symbol of Integrity”. Many participating entities 23, 38 would undoubtedly advertise the availability of the program of a preferred method of the present invention in other forms of their advertisements such as yellow pages, websites 18, mass media such as television and radio, etc. Also, brochures, that explain the details of the method of the present invention as well as pictures of the representative donation tribute keepsake/memento 10 and other customized products to protect, display and store the keepsakes/mementos 11, a display 20 with keepsakes/mementos 11, testimonials, etc. as previously described for a company web page 18, could be available in retail outlets participating in the program and any other appropriate locations.

Another way the program of a preferred method of the present invention could be executed is to have a kiosk 28 (see FIG. 8) for facilitating the program of a preferred method of the present invention. The kiosk 28 could be located inside a retail establishment to service only those customers wishing to participate in the program of a preferred method of the present invention so as to not affect the wait time of customers wishing to purchase the retailer's standard products. The kiosk 28, electronic and manned, could also be located in other strategic locations such as an independent outlet or free-standing location such as in a shopping center, mall or airport. If the retail business does not have the room to accommodate a kiosk 28 or if they simply prefer to process requests for the program of a preferred method of the present invention in the same manner as their other merchandise, a salesperson would obtain the same information necessary to process the donation 19 and keepsake/memento 11 transactions as was previously discussed in the sections on administering the program of a preferred method of the present invention via the Internet and toll-free numbers. As previously discussed, the customer would most preferably be asked to complete the donation transaction before continuing on to purchase the representative keepsake/memento 11.

In point-of-sale situations, the information 41, 42, 43, 44 that is preferably to be inscribed on the keepsake/memento 11 could preferably require the signature of the customer confirming that the information is accurate. Forms could be available (such as those used by the US Post Office for special mailing requests) where consumers could fill out the required information prior to being serviced by the sales representative. The forms could instruct the consumer to fill out the form by printing the information to insure better legibility. This could also serve to increase accuracy. Obviously, the no refund policy for erroneously provided information for the representative donation tribute keepsake/memento 10 would preferably be explained both orally and in print to the customer.

The keepsake/memento 11 could then be personalized and given 34 to the waiting customer (donor 14) or given 34 to the customer to personalize it themselves depending on its design. A customer at an authorized point-of-sale establishment could choose to take 36 the customized/personalized keepsake/memento 11 with them in order to hand deliver 32, 34 it to a specific person or a funeral service 21 where they could place it on the display 20 themselves or any other entity or place 17 that they choose or have it delivered. If the customer requests that the keepsake/memento 11 be delivered, a retailer could charge an additional fee for the delivery or it may be included in the price of the keepsake/memento 11.

All transactions would preferably be acknowledged with a receipt. However, the receipt for the donation transaction could be recorded in a customized numbered and duplicate receipt book so as to keep a registry of the donations 19 separate. This could also serve as a checks and balances system when comparing it to keepsake/memento 11 inventory, hence discouraging anyone from issuing a representative donation tribute keepsake/memento 11 without the customer making the required donation 19. Recording a DCN and having it inscribed on the keepsake not only conforms to the high standard of integrity associated with a preferred method of the present invention but it also serves as a checks and balances system, for example, 1 DCN=1 keepsake/memento. The receipt given to the customer could be used to document the charitable donation 19, a requirement of the IRS when filing annual taxes in order to determine the taxable status of the donation 19.

If an electronic account, such as that used for a gift registry, has to be established in the name 41 of the individual being honored by the method of the present invention because the charity 16, organization or institution is not registered with the IRS or capable of receiving electronic donations 19 (or for other reasons), it could be established and administered by point of sale retailers participating in the program of a preferred method of the present invention, preferably in the general location 17 where the funeral service 21 is to be held. It could also be administered from a remote location that is able to administer the program of a preferred method of the present invention.

It should be noted that any entity licensed to participate in the program of a preferred method of the present invention could have other ways of implementing the program of a preferred method of the present invention that are proprietary in nature.

Another possible alternative may be that a donation tribute 10 could be made independently by an individual directly to a recognized charity 16 or through some other donation processing means and a step in the program of a preferred method of the present invention could be to ask the donor 14 for the payment confirmation number or unique identifier 44, “DCN”, in order to purchase a representative keepsake/memento 11. A charity could link with a web site of an administrator of the program of a preferred method of the present invention or that of a licensee to submit the order for the keepsake/memento 11 by issuing a DCN 44. A DCN 44 could require verification of the user's identity to verify it and the DCN 44 would most preferably only be valid for a single transaction (i.e., one time use). This could function, for example, like the confirmation number or unique identifier one receives when making a payment on-line. This could serve to safeguard the integrity of the program and a DCN 44 could also be used for verifying the donation 19 to the IRS. Development, integration and implementation of a payment or donation confirmation number or unique identifier 44 system could be a component of the program of a preferred method of the present invention. One or more central data bases could be used to incorporate donation confirmation numbers DCN 44 into the program of a preferred method of the present invention or each participating entity in the program of a preferred method of the present invention may be issued a unique block of DCN 44 codes. Also, the DCN code could indicate the identity of the entity that issued it.

The program of a preferred method of the present invention could also have gift certificates that could be purchased to give as a gift to someone else or for the purchaser to use as needed. A DCN 44 could preferably be assigned to each gift certificate that could be used to proceed with the purchase of the representative donation tribute keepsake/memento 10. A DCN 44 could be required on the website 18 and other means of facilitating the method of the present invention in order to follow through with completing the program of a preferred method of the present invention involving the purchase of the representative keepsake/memento 11. Without the traceable/registered DCN 44, the website 18 would preferably not allow a user to advance to screens to purchase the representative donation keepsake/memento 11 associated with the program of a preferred method of the present invention. Gift certificates could possibly also be redeemed by an assigned reference number. Paper versions of the gift certificate could be printed.

Another variation of the program of a preferred method of the present invention could be to have the representative donation tribute keepsake/memento 10 step in the program of a preferred method of the present invention as a link on all and/or any number of IRS recognized charities 16 and/or donation processor websites. When a donor 14 would log on to the charity 16 and/or donation processor's website 18, a link (this could be a button/banner or other icon) representing the keepsake/memento 11 step in the program of a preferred method of the present invention could display the donation keepsake/memento product 11 and asking the donor 14 if they wished to purchase a keepsake/memento 11 representative of their donation 19 in tribute to someone/something (such as a pet). For example, “Would you like to purchase a donation tribute keepsake/memento representative of your donation?” or “Would you like to purchase a tribute keepsake representative of your donation in honor/memory of someone?” This could preferably be, for example, on the home, shopping cart and/or check out pages of the web site or any other appropriate site location. This variation could also be offered in conjunction with the entities participating in the program of a preferred method of the present invention. All necessary billing and delivery information for the keepsake/memento 11 would preferably be obtained. The information could then be forwarded via the Internet to the appropriate entity to process the keepsake/memento 11 request and accomplish delivery of same.

Another variation of the program of a preferred method of the present invention could be to have a national obituary database or form a relationship with one/several of the companies currently providing such information via the Internet. Some examples of existing web sites offering national obituary information are; www.Obituaryregistry.com, which maintains a database with 92% of all current obituaries nationwide, www.eons.com, www.legacy.com. The database could provide the obituary for an individual by keying in the first and last name 41 (middle initial, if available) of the deceased and the city and state they lived along with any other information that could further the accuracy of confirming a match (for example, the approximate date of death, birth date of the deceased, etc.). The database could also provide obituary information by keying in for example, the name of a city, state, zip code, area code, and/or a particular newspaper or a list of local newspapers and the newspaper and/or newspapers in the specific area would display. The newspaper selected could display the obituaries or after selecting the newspaper, one could then navigate to the obituary section of the newspaper. Upon finding the correct obituary for the deceased, a donor 14 could key in information in the required fields (as previously described above, including full name, address, e-mail address, method of payment information, delivery information, etc.), key in an amount that they would like to spend or select an amount from an incremental list and the program could perform the necessary transactions and steps to process the donation 19, generate a receipt and have the keepsake 11 preferably personalized and delivered to the designated place 17 or person 27 preferably at the time of a funeral service 21 so that it could preferably be displayed (or other selected time).

Another variation of the program of a preferred method of the present invention could be to have the program of a preferred method of the present invention as a membership based program. Memberships could have an annual fee for use of the services; a single use fee for the services provided; a lifetime membership fee; as well as other membership plans or the membership could be free. A membership number and/or passcode/password would preferably be assigned to each individual member. This number/passcode/password could be required to enter the website 18. The membership fee, if opted, could cover the costs to amass the services provided. This variation could also accomplish the goals of the program, which is preferably to have a memorial donation represented by a keepsake/memento 11 displayed at the time of a funeral service to honor a decedent. Members could set up an account with the program of a preferred method of the present invention that could keep their billing information on file. This could expedite their future transactions. This alternative membership method could also have other incentives and partners.

The program of a preferred method of the present invention could have a registry of deceased persons enrolled in the program. Two different websites could be available, one for entities 17, 15, 18, 23, 38 participating in the program of a preferred method of the present invention, .com, and one for the general public (consumer) .net. A fee could be charged to use the site or it could be a free service.

An entity administering the program of a preferred method of the present invention could also form a relationship with automatic credit card processing companies, for example Creditline®, U Promise® and/or other types of Payment Gateway.

Another possible way in which the program of a preferred method of the present invention could operate is by licensing funeral service location 17, such as funeral homes. Currently, three major corporations, Service Corporation International, Alderwoods Group Inc., and Stewart Enterprises control the vast majority of the funeral industry. The largest, SCI, has over 1,200 funeral homes, operating in 48 states, eight Canadian provinces and Puerto Rico and has revenues of 1.7 billion dollars. SCI is publicly traded on the New York Stock Exchange. The operational aspects of such a licensing have already been described.

Via the Internet, when a charity 16 is not listed on the national registry, a consumer may be able to proceed with their request of making a charitable donation 19 in memory of someone or something through the program of a preferred method of the present invention by navigating links and/or queries to charities 16 by either linking on to the electronic gift registry in the name 41 of the person being honored or by directly typing in the name and general location of the charity 16. A block could be established in the program to where the purchase of the keepsake/memento 11 could only be accomplished once the charitable donation 19 is complete. Upon confirmation of a donation 19, (for example, a DCN 44) a donor 14 could then proceed to purchase the representative keepsake/memento 11 from an authorized merchant participating in the program of a preferred method of the present invention.

It could also be that the program of a preferred method of the present invention would not require that a donation confirmation number or any confirmation of a donation be provided in order to purchase a keepsake/memento 11.

Existing websites 18 could also be integrated with the program of a preferred method of the present invention to have links that would perform specific functions. For example, a link with JustGive or PayPal, to process donations 19, a link with Teleflora to process the purchase and personalizing of the representative keepsake/memento 11, a link with a delivery service provider 15, etc.

Many charities 16, organizations, institutions, etc, have built a donation link on their website. Some donations 19 could be directly forwarded to the local charity 16 or organization by the entity simply typing in the name of the charity 16 or other organizations along with the name of the town and state they are in as many of them have a “donate now” link on their web site. Some examples are; Jesuit High School, New Orleans, La.; St Dominic Church, New Orleans, La. A consumer may also be able navigate through links and queries to go directly to a decedent's gift registry themselves.

Many churches have positioned themselves to increase their charitable donations by establishing relationships with companies who provide a means of processing donations via credit and debit cards and e-checks. For example, www.MyChurchDonations.com. This company charges a fee for each transaction. A relationship could also be formed with such companies to incorporate the program of a preferred method of the present invention into their services.

Another possible variation to employing the program of a preferred method of the present invention could be to incorporate existing software into the program, for example, FundRaiser Software. This web company works with on-line donation processors such as Star Donor and Echo and processes donations 19 with a “Donate Now” button that is interfaced on a selected website 18, such as that of the program of a preferred method of the present invention or entities participating in the program of a preferred method of the present invention.

The representative donation tribute keepsake/memento 11 could be, for example, a heart-shaped type ornament that has an eye-hole or other cosmetically appealing opening, such as filigree, that could be used to hang the ornament (see FIGS. 4, 10 and 17) or otherwise affix or apply it to a display. A picture frame type hook could secure the keepsake/memento 11 on the display 20 and/or any other fixation devices suited to securing the keepsake/memento 11 to a display could be used 13. A hook, for example a “Hercules Hook”, could serve to easily push and securely affix the keepsake/memento 11 ornament to the display. The ornament-style representative donation tribute keepsake/memento 11 could also be secured by an adhesive back or other suitable fixation apparatus means depending on the keepsake/memento 11 design and type of materials used in its construction, assembly or manufacturing. The fixation device, if not included as part of the keepsake/memento 11 itself, could preferably be included in the keepsake/memento 11 packaging. The keepsake/mementos 11 could be packaged in individual sleeves, boxes, cases, cards, envelopes or other ornate and aesthetically appealing methods and types of packaging.

The public could be offered the option of customizing the keepsake displays 20 and other products of the program of a preferred method of the present invention by selecting from a variety of materials as well as a variety of frames and frame types for the keepsake/memento 11 displays 20. Monogramming or other personalizing of the products customized for the program of a preferred method of the present invention could also be offered. This could be treated as a special order or upon request. Prices preferably could vary based on the types of materials selected. Keepsakes and/or mementos 11 could also be made as a needlepoint product that could be personalized. Keepsake/mementos 11 could also be made from a type of material whereas the keepsake/memento 11 could be a monogrammed gift.

Another possible variation of the program of a preferred method of the present invention, could be to have the representative donation tribute keepsake/memento 10 as an e-card that could be printed, personalized, delivered, and displayed at the funeral service 21. These e-cards, for example, could be sent directly to the funeral service location 17 which could then print them on special cardstock paper or other types and grades of paper products (or other types of materials suited to making cards) customized for the program of a preferred method of the present invention and then have someone (employed or otherwise) take it and place it on the display 20 throughout the period of time the service 21 is scheduled as is the case for floral arrangements. If the keepsake/memento 11 was designed to be a printable e-card, it could also be offered by or sent to other entities, for example florists or other delivery service providers 15, participating in the method of the present invention where it could be personalized and printed on card stock paper or other suitable materials selected for the program of a preferred method of the present invention and delivered to a specified location 17 or individual 27. If the embodiment of the donation representative keepsake/memento 11 were a card, it could be made and/or printed from environmentally friendly processes and/or recycled materials. Regardless of the keepsake's/memento's 11 ultimate design, the donation 19 would most preferably be required prior to purchasing a representative donation tribute keepsake/memento 11.

The card type keepsake/memento 11, e-card or standard type (see FIG. 16), could have information on the front of it, for example, the name 41 of the deceased, the name 42 of the donor 14, the name 43 of the charity 16, the DCN 44 and the donor 14 could write, print or otherwise inscribe a personal note on the back or in the inside. E-card donation tribute keepsake/mementos 11 could be ordered online where a donor 14 could complete all required information necessary to completing the steps in the method of the present invention, type in a personal message for the recipient and the tribute keepsake/memento 11 could be delivered to the requested location 17, 27. The donor 14 could be charged accordingly and the donation 19 forwarded 29 via an independent in-house donation processing system or in conjunction with a link to an established donation processing organization, for example, JustGive. A time frame for delivery of the keepsake/memento 11 could be offered. A donor 14 could also make a tribute donation 10, print out the acknowledgment and bring it to the funeral service 21, mail it to someone or forward it to the funeral home or other funeral service locale 17.

Another variation to employ the program of a preferred method of the present invention if the representative donation tribute 10 keepsake/memento 11 was offered as a card, electronic or otherwise, would be to form a relationship with card companies, for example, Hallmark. Hallmark currently has a website that sells e-cards, traditional cards and other gifts, including floral arrangements. They also have a delivery service for their cards and other gift items. Hallmark also sells ornaments and many other types of gift keepsakes and mementos. Hallmark could also be an interested licensee for the program of a preferred method of the current invention, regardless of the representative donation tribute keepsake/mementos 10 ultimate design.

Myriad entities could be licensed to participate in the program of a preferred method of the present invention, for example, churches, hospitals and hospital gift shops, educational institutions, the military, the Department of Defense, EBay, Amazon, PayPal, other internet companies, retail businesses, Wal-Mart, Target and other department stores, pharmacies, Hallmark, and/or any other legal and solvent entity.

The program could be facilitated, for example, by use of kiosks 28, courtesy desks, vending machines, Internet sites 18 and a toll-free telephone number, fax number, retailers, order forms, gift companies, delivery service providers 15, 17, 23, 38, etc. The program of a preferred method of the present invention could be marketed in a variety of ways including mass media options such as television commercials and radio spots.

Advertising space for the program of a preferred method of the present invention could preferably be purchased in a number of trade magazines and other publications focused on for example, the funeral industry, floral industry, gift industry, philanthropy, entrepreneurial endeavors/business expansion, etc. One example of an ad that could appear in a major publication for funeral directors could read as follows: “For decades you have helped families in their time of grief, now you can help their friends express their condolent respect through a new program that combines donations and displays at a funeral service. To find our more about the program and how you can participate, visit www.charitabletributekeepsake.com or call toll-free 1-888--------.” (Please note that this example of a web address is preferably different from that advertised for the public. The site for the public would preferably be a “.net” address.) This commercial website could also include the entity's economic potential from participation in the program.

Advertising could also appear, for example, in the obituary sections of newspapers; yellow pages; major national and local newspapers and a variety of general and special and general interest magazines (for example, “O” Oprah, “Southern Living,” “Philanthropy Journal,” etc.) nationwide. Brochures on the program of a preferred method of the present invention could be given to all entities participating in the program to display and distribute at their place of business as well as be available at any other reasonable locations. Booths could preferably be acquired for the national conventions of funeral directors, florists, gifts vendors, philanthropists, entrepreneurs, as well as other pertinent groups. The program could have a broad Internet presence that could appear in response to a number of related queries, for example, memorial gifts, “in lieu of”, funerals, charitable donations, tributes, charities, funeral wreaths, etc. An example of an ad intended for the general public could be, for example, “What to do ‘in lieu’? Now you can honor requests for a donation and have it represented by a beautiful Tribute Keepsake that is displayed at the memorial service. You'll also be happy in knowing that your personalized Tribute Keepsake will be a permanent reminder to the surviving family as to the love and respect held for the deceased as it is kept to commemorate the life of their loved one . . . ”.

The floral industry ads will preferably focus on how they can now capitalize on the “in lieu of flowers” and requests for donations trends, that has until the program of a preferred method of the present invention, economically disadvantaged their industry.

The program of a preferred method of the present invention could be used at the discretion of a donor 14 regardless of whether or not their memorial donation tribute 10 was in time for a public or private funeral service 21. This could hopefully accommodate those, who for some reason such as being out of town, did not learn of the death of a person until sometime after the conclusion of the funeral service. Donors 14 could be any one individual, group of individuals, companies, corporations, conglomerates, etc.

As used in the following claims, an honoring acquaintance means an acquaintance, friend, family member, company, or organization who/which wishes to honor a deceased person or thing, such as a pet.

The present invention includes a method of facilitating charitable contributions, comprising in one embodiment a plurality of the following steps (other embodiments are as shown, described and/or claimed herein):

(a) providing a plurality of donation acknowledgment mementos,

(b) providing a donation acknowledgment memento when a donor makes a contribution to a charity;

(c) delivering the donation acknowledgment memento to a site where the donation acknowledgment memento is displayed (usually with like donation acknowledgment mementos);

(d) recording the name of the charity and the amount of the donation;

(e) distributing donated funds to the charities.

Each donation acknowledgment memento could include a space for the name of a charity and the name of a donor, and the method includes the step of filling in the name of the charity and the name of the donor. As the donation acknowledgment mementos are distributed, the method could include the step of recording the name of the donor, the name of the charity, and the amount of the donation.

Preferably, each donation acknowledgment memento includes a unique identifier and the method includes providing a registry of the unique identifiers. Preferably, the method includes the step of, as the donation acknowledgment mementos are distributed, recording in the registry of the unique identifiers the name of the donor, the name of the charity, and the amount of the donation.

A catalog, explaining the program of a preferred method of the present invention and displaying its associated products, may also be offered.

Partnerships/associations/relationships may also be established with charities wishing to have donations acknowledged with the keepsake/mementos of a preferred embodiment of the present invention.

Partnerships/associations/relationships could also be established with donation facilitation and processing entities such as Just Give to have donations acknowledged with a keepsake/memento.

Partnerships/associations/relationships could be established with Catalog Charities such as “Heifer International” to offer keepsakes/mementos through their programs.

The following represents a few schematic examples of how of some of the steps in various methods of the present invention could be sequenced:

1) A donor makes a donation through a donation processor that forwards it to a charity(ies); the donor then purchases the representative gift from a keepsake/memento merchant who is also the delivery service provider that then delivers the gift to the funeral service location where it can be placed on display and upon conclusion of the funeral service is given to the family/friend/other;

2) A donor makes a donation through a donation processor that forwards it to a charity(ies); the donation processor is also a keepsake/memento merchant and delivery service provider that forwards the donation to a charity and also then delivers the representative gift to the funeral service location where it can be placed on a display and upon conclusion of the funeral service is given to family/friend/other;

3) A donor makes a donation directly to a charity(ies) (that may or may not issue a donation confirmation number); the donor then purchases the representative gift from a keepsake/memento merchant who is also a delivery service provider that delivers the representative gift to the funeral service location where it can be placed on display and upon conclusion of the funeral service it is given to the family/friend/other;

4) A donor makes a donation through a donation processor that forwards it to a charity(ies) where the donor receives a donation confirmation number and then purchases the representative gift through a keepsake/memento merchant who is also a delivery service provider that delivers the gift to a funeral service location where it can be placed on display and upon conclusion of the funeral service is given to the family/friend/other;

5) A donor goes to the web site of an entity administering the program of a preferred method of the present invention, keys in the amount they wish to spend and other pertinent data such as billing, keepsake/memento personalization (if applicable) and delivery information and the entity performs the subsequent steps or facilitates the subsequent steps without further work on the part of the donor;

6) A donor makes a donation through a donation processor that forwards it to a charity(ies) and the donation processor and/or the charity offer the representative gift as a product and then contacts/forwards a request to a keepsake/memento merchant(s) who processes the request and delivers the gift or the keepsake/merchant processes the gift request and then contacts a delivery service provider to deliver the representative gift to a funeral service location where it can be placed on display and upon conclusion of the funeral service is given to the family/friend/other;

7) A donor makes a donation directly to a charity(ies) who offers the representative gift and then contacts/forwards a request to a keepsake/memento merchant(s) who processes the request for a gift and delivers the gift or the keepsake/merchant processes the gift request and then contacts a delivery service provider to deliver the representative gift to a funeral location where it can be placed on display and upon conclusion of the funeral is given to the family/friend/other;

8) A donor uses advertised contact information to contact an entity administering a program of a preferred method of the present invention and the program is fully executed by the entity or by a network established by and for the program to fully execute the program.

9) A donor donates to a charity; the charity accepts the donation and sends (as by express delivery service, overnight, two-day, or other) the keepsake/memento to the donor, preferably in time for him to deliver it to the funeral service location prior to the conclusion of the funeral service or to the family; alternatively, the donor can use a delivery service to deliver the keepsake/memento to the funeral service location prior to the conclusion of the funeral service; preferably the keepsake/memento includes a DCN.

It could also be that a single entity could act as the sole entity in executing the program of a preferred method of the present invention, for example, marketing of the program, processing of donations, processing the request for the representative keepsake/memento gift product, issuing a receipt or receipts, delivering the gift product, etc. and/or that entity could also establish its own network of providers to execute the program.

When information is included on the keepsake/memento 11, preferably the names of the charity, donor, and deceased person are in the same size type (such as 12 point type), the DCN is in smaller type and the trademark on the keepsake/memento 11 is in larger type than everything else.

Though not preferred, keepsake/memento 11 could be a balloon, a banner, a streamer, or similar type product often used at celebrations.

The DCN is optional, though preferred.

### PARTS LIST

The following is a list of parts and materials suitable for use in the present invention:

| Parts | |
|---|---|
| Number | Description |
| 10 | keepsake/memento donation tribute apparatus of a |
| | preferred embodiment of the present invention |
| 11 | keepsake/memento gift keepsake representative of the |
| | donation (shown as a heart, but it could be any |
| | appropriate shape, and its shape or color could indicate |
| | a range of donation amount) |
| 12 | keepsake/memento identification card |
| 13 | barbed pin (for example to allow one-step attachment of |
| | the memento apparatus 10 to a display 20) |
| 14 | donor |
| 15 | delivery service provider(s) |
| 16 | charity |
| 17 | funeral service location (such as a funeral home, or a |
| | chapel, or a garden) |
| 18 | web site |
| 19 | donation |
| 20 | display for displaying keepsake/memento apparatus 10 |
| | (such as a board or a bulletin board covered with fabric |
| | or a shadowbox or an easel or a tree) |
| 21 | funeral service |
| 22 | ribbon |
| 23 | participating entity |
| 25 | easel for display 20 |
| 27 | family member(s) or other receiving custody of the |
| | keepsake/memento |
| 28 | vending machine or kiosk or courtesy desk |
| 29 | transmission distribution of donated monies |
| 30 | shadowbox for displaying keepsake/memento apparatus 10 |
| 31 | arrow |
| 32 | arrow |
| 33 | arrow |
| 34 | arrow |
| 36 | arrow |
| 37 | network |
| 38 | keepsake merchant |
| 41 | name of deceased person |
| 42 | name of donor |
| 43 | name of charity |
| 44 | donor or donation or payment confirmation number of |
| | unique identifier |
| 130 | shadowbox frame |
| 230 | folding book-type display |
| 314 | insert or sleeve |

All measurements disclosed herein are at standard temperature and pressure, at sea level on Earth, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims.

The foregoing embodiments are presented by way of example only; the scope of the present invention is to be limited only by the following claims.

1-430. (canceled)

431. A method for providing tangible representation for charitable donations made in tribute to a deceased person in the form of a memorial gift that is displayed at the funeral service of the decedent comprising one or more of the following steps:
a) providing a tangible representation of a donation made in tribute to a deceased person in the form of a keepsake/memento memorial gift when a donor/honoring acquaintance makes a contribution in honor of a decedent;
b) facilitating provision of a tangible representation of a donation in the form of a keepsake/memento memorial gift when a donor makes a contribution in honor of a deceased person;
c) enabling a purchaser to place an order for the donation representative memorial gift, the order including a price that is paid by the purchaser;
d) providing one or more delivery service providers that enable delivery of the donation acknowledgement memorial gift product to a funeral service of the deceased at a funeral service location;
e) delivering a memento/keepsake memorial gift to a funeral service of the deceased so that the memento/keepsake memorial gift may be displayed prior to the conclusion of the funeral service and/or given to a representative of the decedent;
f) facilitating delivery of the donation acknowledgement memento/keepsake memorial gift to a funeral service location of the deceased person so that the memento/keepsake memorial gift may be displayed prior to the conclusion of the funeral service and/or given to a representative of the deceased person;
g) facilitating display of the keepsake/memento memorial gift in a common location at the funeral service of the decedent.

432. The method of claim 431, wherein the memorial gift is representative of the charitable donation made in honor of the deceased.

433. The method of claim 431, where step “a” and step “b” are performed a plurality of times for multiple honoring acquaintances/donors wishing to make charitable donations causing multiple tangible representations of the donation in the form of a memento/keepsake memorial gift to be displayed at the funeral service location prior to the conclusion of the funeral service.

434. The method of claim 431, wherein in step “c” the purchaser pays a fee, in addition to the donation, to the provider of the donation acknowledgement memento/keepsake memorial gift.

435. The method of claim 431, further comprising displaying the donation acknowledgement memorial gift memento/keepsakes of step “a” in a common location at the funeral service of a decedent.

436. The method of claim 431, wherein in step “g” the common location is a display and the donation acknowledgement memento/keepsakes are attached to the display.

437. The method of claim 431, wherein in step “g” the donation acknowledgement memento/keepsake is displayed with like donation acknowledgement memento/keepsakes.

438. The method of claim 431, wherein the keepsake/memento donation acknowledgement memorial gift(s) and/or display is given to the surviving family or a representative of the deceased following the conclusion of the memorial service.

439. The method of claim 431, wherein products customized for the method are given and/or offered for sale to the surviving family and/or representative of the deceased to display, house, protect, and/or store the keepsake/memento gift(s).

440. A method of establishing a “one-stop-shopping” program for a person(s) wishing to honor a decedent with a donation tribute “in lieu of” or in addition to other memorial gifts whereby the donation is tangibly represented by a memorial gift product in the form of a keepsake/memento gift that is displayed before, at the time of and/or prior to the conclusion of a funeral service for the deceased comprising one or more of the following steps:
(a) (i) facilitating a donation to a charity, or
(ii) accepting a donation on behalf of a charity, or
(iii) confirming that a donation to a charity has been made, or
(iv) receiving a representation that a donation to a charity has been made; and
(b) (i) advertising or otherwise making known availability of a service offering a memento/keepsake, the memento/keepsake being a tangible representation of a donation made in honor of a deceased person that is displayed prior to the conclusion of the funeral service of the decedent, or
(ii) providing a tangible representation of the donation tribute in the form of a keepsake/memento memorial gift when a donor makes a contribution in honor of a deceased person, or
(iii) facilitating provision of a tangible representation of the donation in the form of a keepsake/memento memorial gift when a donor makes a contribution in honor of a deceased person; and
(c) facilitating delivery of a memento/keepsake to a funeral service of the deceased person at a funeral service location so that the memento/keepsake may be displayed before the conclusion of the funeral service and/or given to a representative of the deceased person; and
(d) receiving instructions to deliver; and
(e) advertising or otherwise making known availability of a service to deliver a memento/keepsake, the memento/keepsake being a tangible representation of a donation made in honor of the deceased, to a funeral service of the deceased person at a funeral service location so that the memento/keepsake may be displayed before the conclusion of the funeral service and/or given to a representative of the deceased person, or
(f) delivering the memento/keepsake to a funeral service of the deceased person at a funeral service location so that the memento/keepsake may be displayed before the conclusion of the funeral service, the memento/keepsake being a tangible representation of the donation; and
(g) facilitating display of the keepsake/mementos in a common location at the funeral service of the deceased person; and
(h) displaying the keepsake/mementos in a common location at the funeral service of the deceased person; and
(i) providing a receipt as evidence of the donation transaction; and
(j) facilitating provision of a receipt as evidence of the donation transaction; and
(k) providing a receipt as evidence of the keepsake/memento memorial gift product transaction; and
(l) facilitating provision of a receipt as evidence of the keepsake/memento memorial gift product transaction.

441. The method of claim 440 wherein in step “i” a receipt is issued to identify tax exempt status of the donation.

442. The method of claim 440 wherein in step “i” and step “k” the receipt is issued to the donor/purchaser.

443. The method of claim 440, wherein the step of facilitating a monetary transaction for the donation, the step of facilitating a monetary transaction for the form and the step of providing a receipt evidencing the donation are performed together.

444. The method of claim 440, wherein a single charge is made for the charitable donation and the cost of the tangible memento/keepsake and its delivery and display is part of the single charge.

445. The method of claim 440, wherein the price is paid in two or more transactions.

446. The method of claim 440, wherein a computer program determines all processing fees and the amount of the donation

447. The method of claim 440, wherein in step “b” the donation representative keepsake/memento memorial gift carries information inscribed thereon, attached thereto or included along with.

448. The method of claim 447, wherein the provider of the donation representative keepsake/memento personalizes the keepsake/memento according to instructions received from the honoring acquaintance.

449. The method of claim 440, wherein the honoring acquaintance participates in the program using a telephone, mobile wireless phone or other electronic voice device.

450. The method of claim 440, wherein the honoring acquaintance participates in the program using a computer.
